(19) United States
(12) Patent Application Publication
(10) Pub. No.: US 2025/0256528 A1
(43) Pub. Date: Aug. 14, 2025

(54) OPTICAL DEVICES AND METHODS OF MANUFACTURE THEREOF

(71) Applicant: DE LA RUE INTERNATIONAL LIMITED, Basingstoke, Hampshire (GB)

(72) Inventors: Brian HOLMES, Basingstoke (GB); Frederic FOURNIER, Basingstoke (GB); Maria KING, Basingstoke (GB)

(73) Assignee: DE LA RUE INTERNATIONAL LIMITED, Basingstoke, Hampshire (GB)

(21) Appl. No.: 18/854,738

(22) PCT Filed: Apr. 12, 2023
(86) PCT No.: PCT/GB2023/050988

§ 371 Date: Oct. 7, 2024

(30) Foreign Application Priority Data
Apr. 14, 2022 (GB) 2205574.3

(51) Int. Cl. B42D 25/328; B42D 25/24; B42D 25/29; B42D 25/324; B42D 25/425; G02B 5/18

(52) U.S. Cl. CPC B42D 25/328; B42D 25/324; G02B 5/1828; B42D 25/24; B42D 25/29; B42D 25/425

(57) ABSTRACT

An optical device that exhibits a variable optical effect upon illumination is provided. The optical device comprises a set of first grating regions, wherein each first grating region comprises a plurality of first grating elements. The first grating elements have one or more first grating pitches such that upon illumination the first grating elements exhibit at least a first order diffractive effect at a first viewing angle and a second order diffractive effect at a second viewing angle. The optical device further comprises a set of second grating regions, wherein each second grating region comprises a plurality of second grating elements, the second grating elements having one or more second grating pitches smaller than the one or more first grating pitches such that upon illumination the second grating elements exhibit a first order diffractive effect substantially at the second viewing angle. The set of first grating regions is interlaced with the set of second grating regions. The first grating elements are arranged in accordance with a first image and the second grating elements are arranged in accordance with a second image, such that a user viewing the device perceives the first image at the first viewing angle and perceives the second image at least partially overlapping the first image at the second viewing angle.

### FIELD OF THE INVENTION

The present invention is directed to optical devices and their method of manufacture. The invention is particularly applicable to the field of security devices, where such optical devices may be used as means of determining the authenticity of a security document such as a banknote or passport.

### BACKGROUND

Articles of value, and particularly documents of value such as banknotes, cheques, passports, identification documents, certificates and licences, are frequently the target of counterfeiters and persons wishing to make fraudulent copies thereof and/or changes to any data contained therein. Typically such documents are provided with a number of visible optical devices acting as security devices for checking the authenticity of the object. By “security device” we mean a feature which is not possible to reproduce accurately by taking a visible light copy, e.g. through the use of standardly available photocopying or scanning equipment. Examples include features based on one or more patterns such as microtext, fine line patterns, latent images, venetian blind devices, lenticular devices, moiré interference devices and moiré magnification devices, each of which generates a secure visual effect. Other known security devices include holograms, watermarks, embossings, perforations and the use of colour-shifting or luminescent/fluorescent inks. Common to all such devices is that the visual effect exhibited by the device is extremely difficult, or impossible, to copy using available reproduction techniques such as photocopying. Security devices exhibiting non-visible effects such as magnetic materials may also be employed.

One class of optical devices are those which produce an optically variable effect, meaning that the appearance of the device is different at different angles of view and/or illumination. Such devices are particularly effective as security devices since direct copies (e.g. photocopies) will not produce the optically variable effect and hence can be readily distinguished from genuine devices. Optically variable effects can be generated based on various different mechanisms, including holograms and other diffractive devices, moiré interference and other mechanisms relying on parallax such as venetian blind devices, and also devices which make use of focusing elements such as lenses, including moiré magnifier devices, integral imaging devices and so-called lenticular devices.

The present invention is directed to diffractive devices that produce an optically variable effect. When white light is incident upon a diffraction grating, it is split into its constituent wavelengths (i.e. colours) according to the diffraction grating equation:

$$P ( sin {θ}_{i} \pm sin {θ}_{d} ) = m λ , \qquad ( Equation 1 )$$

where P is the pitch of the grating elements of the diffraction grating (i.e. the spacing between adjacent grating elements), m is the diffraction order, λ is the wavelength of light, and θᵢ and θ_{d} are the angle of incidence and diffraction, respectively, of light measured relative to the plane normal of the diffraction grating. This effect can be used to generate optical devices that exhibit diffractive colour images at particular viewing (“tilt”) angles corresponding to the angle of diffraction when the device is illuminated.

Rotating an optical device within its plane in order to observe an optically variable effect is an ergonomic and natural motion for an observer. However, conventional diffraction gratings will typically exhibit a second diffraction order, if rotated enough, at which essentially the same effect is replayed but with significantly reduced brightness. This effect is generally undesirable, but is necessary in order to have a diffractive effect that is exhibited at natural viewing angles.

It is an object of the invention to devise new optical devices that do not suffer from this issue.

### SUMMARY OF INVENTION

In accordance with a first aspect of the invention, there is provided an optical device that exhibits a variable optical effect upon illumination, comprising: a set of first grating regions, wherein each first grating region comprises a plurality of first grating elements, the first grating elements having one or more first grating pitches such that upon illumination the first grating elements exhibit at least a first order diffractive effect at a first viewing angle and a second order diffractive effect at a second viewing angle; a set of second grating regions, wherein each second grating region comprises a plurality of second grating elements, the second grating elements having one or more second grating pitches smaller than the one or more first grating pitches such that upon illumination the second grating elements exhibit a first order diffractive effect substantially at the second viewing angle; and wherein the set of first grating regions is interlaced with the set of second grating regions, and wherein the first grating elements are arranged in accordance with a first image and the second grating elements are arranged in accordance with a second image, such that a user viewing the device perceives the first image at the first viewing angle and perceives the second image at least partially overlapping the first image at the second viewing angle.

The invention therefore provides a device that displays a first diffractive image, typically a coloured diffractive image, that is provided by a first set of diffraction gratings that exhibit both first and second order diffraction. However, the second set of diffraction gratings is provided with a pitch selected such that the second diffractive image, which is typically a coloured diffractive image, exhibited by its first order diffractive effect coincides with the second order diffractive effect of that first set of diffraction gratings. The effect of this arrangement is that the second image dominates the appearance of the device, at least in the region of the overlap of the two images, at the second viewing angle. The second image may therefore conceal the first image, at least in the region of the overlap of the two images. This is because, typically, a first diffraction order is at least an order of magnitude brighter than a second diffraction order. Thus, a viewer viewing the device at the first viewing angle will initially see the first image exhibited by the set of first grating regions and will not see any effect from second grating regions, but when they rotate the device to the second viewing angle, at which the second diffraction order would normally be visible, they will see the second image exhibited by the set of second grating regions. The first image will still be exhibited by the set of first grating regions at this second viewing angle; however, because of the comparative brightness of the second image and the at least partial overlap of the two images, the appearance of the device at this angle will be dominated by the second image.

In the present context, the first diffraction order and the second diffraction order refer to those diffraction orders for visible light. Herein, the visible part of the electromagnetic spectrum is considered to be between about 390 nm to 700 nm. It will be appreciated that the first diffraction order and the second diffraction order for a particular grating structure can be determined from the diffractive structure itself, i.e. using the diffraction grating equation. Therefore, in practice, the designer of the optical device may choose a grating structure for the first grating regions which exhibits a first order effect at particular angle under typical viewing conditions. For example, optical devices used for security documents, such as bank notes, are typically illuminated from above and held roughly vertical when being inspected for authenticity. Once the grating structure for the first grating regions is selected, the angle of its second diffraction order may be determined from the diffraction grating equation, and a grating structure may then be selected for the second grating regions which exhibits its first order effect at the same angle. In line with the diffraction grating equation, the pitch of the structure in the second grating regions must be smaller than that in the first grating regions such that its first diffraction order is exhibited at the same angle as the second diffraction order of the grating in those first grating regions.

As noted above, first set of grating regions is interlaced with the set of second grating regions so that the first and second images may be perceived as at least partially overlapping. It will be appreciated that, because of the interlacing, the first and second grating regions may not overlap with one another at any point on the device; however, since the image displayed is perceived from the combination of those grating regions, the interlacing provides that the images may be perceived in the same areas of the optical device, enabling the images to be perceived as partially overlapping. As will be discussed in more detail below, this effect will be most pronounced when the scale of the interlacing is imperceptible to the naked eye. It should be noted here that the interlacing of the first and second regions is preferably regular, e.g. alternating between first and second regions of the same size along at least one direction of the device; however, this is not essential, and the regions could also be irregularly interlaced.

The first and second grating regions are arranged in accordance with respective images. Each grating region may be thought of as a small part of the corresponding image being presented. If the first image is, for example, a coloured letter or number on a blank background, then the first grating regions should be provided in areas corresponding to the coloured body of the letter or number and omitted in areas outside of the coloured body of the letter or number so that when the diffractive effect of these gratings is visible, the viewer sees the letter or number defined by optically active regions against a blank background provided by areas in which the first grating regions are omitted. The interlacing of the first and second regions allows this arrangement to be provided for two different images within the same area of the optical device. Preferably, these first and second images are diffractive colour images, i.e. having a coloured appearance at least at the first and second viewing angles respectively.

It should also be noted that the first and second images will generally not be visible at only one viewing angle for a number of reasons including typical diffuse lighting conditions and also the dispersive nature of diffraction gratings. Typically, the first image may be visible in the first diffraction order over a first range of viewing angles and in the second diffraction order over a second range of viewing angles in a viewing plane of the set of first grating elements, corresponding to the plane of diffractive dispersion. The second image may then be visible in the first diffraction order of the set of second grating elements over a range of viewing angles overlapping said second range of viewing angles. Preferably, a viewing plane of the set of second grating elements, i.e. the plane of diffractive dispersion, is aligned with that of the set of first grating elements. In other words, preferably grating elements have substantially the same orientation in the plane of the device. Preferably, the second range of viewing angles is entirely overlapped by the range of viewing angles of the first diffraction order of the second set of grating regions.

Typically, the one or more second grating pitches are equal to substantially half of the one or more first grating pitches, e.g. within a tolerance of 50 nm or 10%, as according to the diffraction equation, this will cause the first order of the smaller pitch grating to coincide with the second order of the larger pitch grating. While this is preferred, other arrangements are envisaged, such as where the first and second grating regions are provided on differently inclined surface elements.

In some embodiments, the second image could be the same as the first image, and the two images may be aligned. This would boost the brightness of the image at the second viewing angle, to prevent the effect of a second duller version of the image appearing at the second viewing angle. However, preferably, the second image is different from the first image, such that a user viewing the device perceives a switch from the first image to the second image upon moving from the first viewing angle to the second viewing angle. As mentioned above because a first diffraction order is typically much brighter than a second diffraction order, the appearance of the device at the second angle will be dominated by the second image, even in the case that the images only partially overlap, giving the impression of a switch from one image to another upon rotation, which is an optical effect well understood for authentication purposes by the typical user.

As indicated above, viewing angles of these different diffractive effects will be determined by the pitch of the diffraction grating elements. Therefore, preferably, the one or more first grating pitches are between 600 nm and 1500 nm, preferably between 700 nm and 1200 nm, and/or wherein the one or more second grating pitches are less than 700 nm, preferably less than 550 nm, and/or between 300 nm and 700 nm, preferably between 300 nm and 600 nm. The former pitches correspond to conventional diffraction gratings. These generally have first diffraction orders relatively close to the angle of specular reflection, which is preferred for typical viewing conditions, but and as a result have a second diffraction order that is also within typical rotation angles of the device. The latter pitches generally correspond to sub-wavelength gratings, and these gratings have first diffraction orders further removed from angle of specular reflection. This makes these generally unsuitable for typical viewing conditions, as they typically require a large amount of rotation before the effect is visible, and then the effect progresses relatively slowly. However, in the case of the present device, such gratings work well in combination with the larger pitch gratings which provide the more easily accessed diffractive effect. Furthermore, it is preferred that the second grating elements do not exhibit a second order diffraction effect. This will prevent the second image from being visualised in dimmer form in a second diffraction order, which would be undesirable for the reasons described. To ensure that the second grating elements do not exhibit a second order diffraction effect, the one or more second pitches should be less than the wavelength of visible light.

The angle at which a diffraction order is exhibited is influenced by both the pitch and the wavelength of light, i.e. its colour. The effect of the second image concealing or dominating over the first image will be strongest where the images at the second viewing angle are the same colour. Therefore, preferably the one or more first and second grating pitches are selected such that the second image exhibited at the second viewing angles comprises substantially the same one or more diffractive colours as exhibited in the first image at the second viewing angle. While this is preferred, it is not essential, since the higher brightness of the second grating regions at the second viewing angle will ensure that the image will still dominate the appearance of the device.

Because, the angle of a diffraction order is determined by both wavelength and pitch, to have two different colours (i.e. different wavelengths) exhibited at the same viewing angle, it will be necessary to have to different gratings with different pitches for exhibiting those colours. Therefore, preferably the first grating regions comprise a plurality of first grating regions and/or sub-regions having different first grating pitches, such that said first grating regions and/or sub-regions exhibit multiple diffractive colours at the first and second viewing angles. Similarly, preferably the second grating regions comprise a plurality of second grating regions and/or sub-regions having different second grating pitches, such that said second grating regions and/or sub-regions exhibit multiple diffractive colours at the second viewing angle. This increases the complexity and hence the security of the device, and furthermore the use of multiple colours can assist in allowing the second image to dominate over the first image, as the higher complexity prevents the viewer from recognising the first image at the second viewing angle. To ensure that the different colours within one image replay at the same viewing angle, preferably the different first grating pitches differ by no more than 500 nm, preferably by no more than 300 nm, further preferably by no more than 200 nm, and preferably the different second grating pitches differ by no more than 300 nm, preferably no more than 200 nm, more preferably no more than 150 nm. Typically, said first grating regions and/or sub-regions having different first grating pitches are arranged in accordance with the different colours of the first image, and/or said second grating regions or sub-regions having different second grating pitches are arranged in accordance with the different colours of the second image. It should be noted that the use of gratings having different pitches includes grating regions that are wholly one pitch or another, with the pitch differing from one grating region to the next, as well as individual grating regions that are composed of multiple sub-regions having gratings of different pitches.

In embodiments that use multiple colours within the first and second images, preferably the first grating regions are configured, e.g. arranged, such that the first image exhibited at the first and second viewing angles comprises a plurality of distinct areas of at least two distinct colours, and the second grating regions are configured such that the second image exhibited at the second viewing angle comprises a plurality of distinct areas of substantially the same two distinct colours, wherein the areas of those same colours are perceived to at least partially overlap at the second viewing angle. In other words, because colours in the first image are best concealed by a corresponding colour in the second image, it will be preferred that areas of different colours in the first image are at least partially overlapped by areas of substantially the same colour in the second image. Preferably, at least 50% of each area in the first image will be overlapped by an area of substantially the same colour in the second image, more preferably 75%, even more preferably 90%, and most preferably each area in the first image will be substantially entirely overlapped by an area of substantially the same colour in the second image.

A diffraction grating generally exhibits its diffractive effect in its plane of diffractive dispersion, being the plane that is perpendicular to the direction along which the grating elements extend. This is assuming that the grating is illuminated from within this plane. Once a viewer moves out of this plane, the diffractive effect quickly disappears. In some embodiments, the first grating elements and the second grating elements all have substantially the same orientation within the plane of the device, often referred to as the azimuthal orientation of the gratings or the orientation relative to the horizontal direction when along the substrate normal. Where the gratings are linear grating elements, for example, this may provide a sharp and bright optical effect. However, this can mean that diffractive images are too difficult to locate during authentication. One way to address this is to provide grating elements that are curved, e.g. with constant curvature or varying curvature. Each point on a curved grating element provides a different grating vector orientation, such that the diffractive optical effect may be observed for a greater range of rotation viewing angles. However, as indicated above, it is generally preferred that the first and/or second grating elements are linear grating elements. Therefore, as an alternative, one or more, preferably each, of the first and/or second grating regions may comprise a plurality of sub-regions including gratings elements having different orientations. The gratings in these sub-regions could differ by as much as 90° from one another within the same first or second grating regions. However, preferably, one or more, preferably each, of the first grating regions comprises a plurality of first grating sub-regions, wherein the first grating elements of said first grating sub-regions have different orientations within the plane of the device, wherein preferably the different orientations differ by 60° or less, preferably by 40° or less, more preferably by 30° or less, most preferably by 20° or less or less, and/or one or more, preferably each, of the second grating regions comprises a plurality of second grating sub-regions, wherein the second grating elements of said second grating sub-regions have different orientations within the plane of the device, wherein preferably the different orientations differ by 60° or less, preferably by 40° or less, more preferably by 30° or less, most preferably by 20° or less. The use of different sub-regions with different, but relatively similar, orientations, allows the same image to be visible for a greater range of rotation viewing angles.

As mentioned above, an advantage of the present device is that the second image dominates the appearance of the device, at least in the region of the overlap of the two images, at the second viewing angle. It will generally be preferred for the device to exhibit a clean image switch, so that a viewer perceives only the first image at the first viewing angle and perceives substantially only the second image at the second viewing angle. Therefore, preferably, the first and second grating regions are arranged such that the second image dominates the appearance of the device at the second viewing angle. The complexity of the images and their degree of overlap can be used to control this effect. Preferably, the first and second grating regions are arranged such that the second image is perceived as overlapping the first image by at least 50% at the second viewing angle, i.e. at least 50% of the first image is concealed by the second image, which is typically an order of magnitude brighter. Of course, the grater the extent of the overlap, the less the first image will be perceived at the second viewing angle, and so further preferably, the first and second grating regions are arranged such that the second image is perceived as overlapping the first image by at least 75%, more preferably by at least 90%. In the most preferred case, the second image is perceived as substantially entirely encompassing the first image at the second viewing angle. This may be achieved by providing the second image as a contiguous area larger than the first image, such that the first image may appear within the area defined by the second image.

As indicated above, the first and second grating regions are interlaced with one another across the device. The perception of the images exhibited by the first and second grating regions will be improved if the dimensions of each grating region are such that they are not discernible to the naked human eye. However, even in cases where the regions are discernible to the naked human eye, the images may still be recognisable. The human eye is commonly understood to have an angular resolution of approximately 1 minute of ac. The means that an observer viewing the optical device at a distance of (generally) between 25 cm and 30 cm may resolve features having dimensions between approximately 75 microns and 100 microns, allowing for imperfections of the human eye. Generally, each grating region has a narrowest dimension in the plane of the device of not more than 70 microns, preferably not more than 50 microns, more preferably no more than 30 microns. Indeed, in some cases, each grating region may have these dimensions in at least two orthogonal directions in the plane of the device.

The interlacing of the grating regions could be a one dimensional interlacing. That is, each grating region could be elongate along a first direction, and the grating regions could be interlaced along a second direction orthogonal to the first direction. However preferably, the set of first grating regions is interlaced with the set of second grating regions in a grid pattern, such that the first grating regions are interlaced with the second grating regions along two directions. The repeating dimension of the interlacing is preferably smaller than that resolvable by the naked human eye in order to avoid “macro” pattern artefacts being perceived when viewing the device. Thus typically, a repeat distance of the interlacing (e.g. the sum of the dimensions of adjacent first and second grating regions) is typically less than 100 microns, preferably less than 75 microns and more preferably 60 microns or less. Preferably, the first grating regions and the second grating regions are arranged in a substantially contiguous manner.

The grating regions of the present device will preferably be coated with a reflection enhancing layer, preferably one that follows the contours of the relief structure, to enhance the brightness of the effects.

It will be appreciated that the present optical device is not limited to only two sets of grating regions and could further include a set of third grating regions interlaced with the set of first grating regions and the set of second grating regions, and possibly further sets of grating regions. A third set of grating regions could be used, for example, to exhibit a third image, e.g. at a third viewing angle different from the first and second viewing angles. This could be used to introduce further complexity to the device; however, the advantages described above will still be achieved by providing the first image visible in first and second diffraction orders and the second image overlapping the first image where it is exhibited in that second diffraction order.

The surface relief may have different profiles, such as a sinusoidal, rectangular or triangular profile. The type of surface relief profile may affect diffraction efficiency, but it is the pitch of the grating elements that determines the angular dispersion or “spread” of colours-and hence the colour exhibited by a region at a particular tilt angle. Typically the profile depth of a surface relief defining the grating elements is no greater than 1000 nm, preferably no greater than 500 nm.

The device of the present invention may further comprise non-diffractive regions, wherein each non-diffractive region comprises an absence of grating elements. Such non-diffractive regions typically comprise a uniform (e.g. planar) metallisation and exhibit substantially the same optical appearance (typically black) at substantially all angles of view of the device (i.e. all rotational angles and all tilt angles). The non-diffractive regions may be used to provide backgrounds to the first and second images, or to augment the variable optical effect or to provide further information, for example.

Particularly preferably, the optical device of the present invention is a security device. In other words, the security device may be used to prevent copying or counterfeiting of an article or document to which it is applied. Typically, a “security device” is not possible to reproduce accurately by taking a visible light copy, e.g. through the use of standardly available photocopying or scanning equipment.

In accordance with a second aspect of the invention there is provided a security article comprising a security device according to the first aspect of the invention, wherein the security article is preferably formed as a security thread, strip, foil, insert, patch, or substrate for a security document.

In accordance with a third aspect of the invention there is provided a security document comprising a security device or a security article according the second aspect of the invention, the security document preferably comprising a banknote, cheque, passport, identity card, certificate of authenticity, fiscal stamp or another document for securing value or personal identity.

In accordance with a fourth aspect of the invention, there is provided a method of manufacturing an optical device that exhibits a variable optical effect upon illumination, the method comprising: forming a diffractive structure in a carrier layer, the diffractive structure comprising: a set of first grating regions, wherein each first grating region comprises a plurality of first grating elements, the first grating elements having one or more first grating pitches such that upon illumination the first grating elements exhibit at least a first order diffractive effect at a first viewing angle and a second order diffractive effect at a second viewing angle; a set of second grating regions, wherein each second grating region comprises a plurality of second grating elements, the second grating elements having one or more second grating pitches smaller than the one or more first grating pitches such that upon illumination the second grating elements exhibit a first order diffractive effect substantially at the second viewing angle; and wherein the set of first grating regions is interlaced with the set of second grating regions, and wherein the first grating elements are arranged in accordance with a first image and the second grating elements are arranged in accordance with a second image, such that a user viewing the device perceives the first image at the first viewing angle and perceives the second image at least partially overlapping the first image at the second viewing angle.

The resulting device provides all of the benefits already discussed above.

In preferred embodiments the diffractive structure is formed by: providing a replication tool having a surface relief defining the diffractive structure; and using the replication tool to form the surface relief of the carrier layer according to the surface relief, and preferably applying a reflection enhancing layer onto the carrier layer so as to follow the contours of the surface relief. The replication tool may be manufactured by creating the surface relief in a recording medium and preferably transferring the surface relief to the surface of the replication tool.

The surface relief may be formed in the recording medium using maskless lithography such as electron beam lithography or direct laser writing. Electron beam lithography and direct laser writing can produce grating elements with pitches or spacings less than 500 nm.

In accordance with a fifth aspect of the invention, there is provided an optical device that exhibits a variable optical effect upon illumination, comprising: a set of first grating regions, wherein each first grating region comprises a plurality of first grating elements, wherein at least a subset of the first grating regions comprise first achromatic grating regions, wherein each first achromatic grating region comprises a plurality of first achromatic grating sub-regions having different respective grating element pitches ranging from a coarse pitch to a fine pitch and arranged such that, for a plurality of viewing angles within a first viewing zone, the diffractive colours exhibited by the plurality of first achromatic grating sub-regions upon illumination cooperate such that the first achromatic grating region is perceived to exhibit diffractive whiteness by a viewer viewing the device, and wherein at least a subset of the first grating regions comprise second achromatic grating regions, wherein each second achromatic grating region comprises a plurality of second achromatic grating sub-regions having different respective grating element pitches ranging from a coarse pitch to a fine pitch and arranged such that, for a plurality of viewing angles within a second viewing zone, the diffractive colours exhibited by the plurality of second achromatic grating sub-regions upon illumination cooperate such that the second achromatic grating region is perceived to exhibit diffractive whiteness by a viewer viewing the device, wherein the grating elements of the second achromatic grating regions have a different average orientation from the grating elements of the first achromatic grating regions, such that the first and second viewing zones are different; a set of second grating regions, wherein each second grating region comprises a plurality of second grating elements, the second grating elements having one or more second grating pitches, wherein the one or more second grating pitches are smaller than the pitches of the grating elements in at least 80% of the first and/or second achromatic grating sub-regions, such that upon illumination the second grating elements exhibit a first order diffractive effect at least at a first viewing angle, the second grating elements being arranged, i.e. arranged in accordance with a colour image, such that a user viewing the device at the first viewing angle perceives a diffractive colour image; and wherein the set of first grating regions is interlaced with the set of second grating regions such that a user viewing the device at the first viewing angle perceives the diffractive colour image as at least partially overlapping one or more areas of diffractive whiteness exhibited by the achromatic grating regions.

This device uses achromatic grating regions to provide diffractive effects in two different viewing zones. Such achromatic grating regions may exhibit distinct second orders, but as a result of inherently having a variety of different colours and diffraction orders overlapping at any one viewing angle over a range of viewing angles, these structures appear to progress gradually between first and second order effects, and so the presence of these second diffraction orders does not appear as a distracting and unexpected repetition of the first order effect.

However, these achromatic grating regions do not exhibit the distinct colours that a viewer is accustomed to seeing in diffractive devices, and so by supplementing these achromatic grating effects with the diffractive colour image from the set of second grating regions, which is perceived to overlap or more regions of diffractive whiteness, a complex and secure diffractive colour switching effect may be provided. Furthermore, because the one or more second grating pitches are smaller than the pitches of the grating elements in at least 80% of the first and/or second achromatic grating sub-regions, the first diffraction order of the diffractive effect of the second grating regions may coincide with one or both of the diffractive whiteness effects where they are primarily produced by second diffraction orders of their achromatic grating regions. Accordingly, at the first viewing angle, the diffractive colour image may dominate the appearance of the device and/or conceal the diffractive whiteness effects, at least where it overlaps the one or more areas of diffractive whiteness.

In alternative versions of this aspect, there may be provided an optical device that exhibits a variable optical effect upon illumination, comprising: a set of first grating regions, wherein each first grating region comprises a plurality of first grating elements, wherein at least a subset of the first grating regions comprise first achromatic grating regions, wherein each first achromatic grating region comprises a plurality of first achromatic grating sub-regions having different respective grating element pitches ranging from a coarse pitch to a fine pitch and arranged such that, for a plurality of viewing angles within a first viewing zone, the diffractive colours exhibited by the plurality of first achromatic grating sub-regions upon illumination cooperate such that the first achromatic grating region is perceived to exhibit diffractive whiteness by a viewer viewing the device, and wherein at least a subset of the first grating regions comprise second achromatic grating regions, wherein each second achromatic grating region comprises a plurality of second achromatic grating sub-regions having different respective grating element pitches ranging from a coarse pitch to a fine pitch and arranged such that, for a plurality of viewing angles within a second viewing zone, the diffractive colours exhibited by the plurality of second achromatic grating sub-regions upon illumination cooperate such that the second achromatic grating region is perceived to exhibit diffractive whiteness by a viewer viewing the device, wherein the grating elements of the second achromatic grating regions have a different average orientation from the grating elements of the first achromatic grating regions, such that the first and second viewing zones are different; a set of second grating regions, wherein each second grating region comprises a plurality of second grating elements, the second grating elements having one or more second grating pitches such that upon illumination the second grating elements exhibit a first order diffractive effect at least at a first viewing angle, the second grating elements being arranged, i.e. arranged in accordance with a colour image, such that a user viewing the device at the first viewing angle perceives a diffractive colour image; and wherein the set of first grating regions is interlaced with the set of second grating regions such that a user viewing the device at the first viewing angle perceives the diffractive colour image as at least partially overlapping one or more areas of diffractive whiteness exhibited by the achromatic grating regions. This device would differ in that it would not be essential for the second grating elements to have the pitches defined above relative to the pitches of the achromatic grating sub-regions.

Preferably, the second grating elements have a different average orientation from the grating elements of both the first and second achromatic grating regions. It should be noted that the diffractive whiteness effects from either or both of the first and second achromatic grating regions may or may not be exhibited at the first viewing angle, depending on the one or more orientations used for the grating elements in the achromatic grating regions and in the second grating regions. As will be discussed below, the grating elements could be curved or could be provided with multiple orientations so that the effects are visible over a lateral spread of viewing angles Indeed, in many cases, it may be preferred for one or both of the diffractive whiteness effects to be at least partially visible at the first viewing angle, which can be achieved by providing the first and/or second achromatic grating regions with curved grating elements or multiple orientations, as will be described below. Even in cases in which the diffractive whiteness is not exhibited at the first viewing angle, the viewer inspecting the device will recognise that the diffractive colour image is appearing in an area of the device that at least partially overlaps with one or more areas of diffractive whiteness, i.e. the areas that appear white at least when viewing the device in the first or second viewing planes. The viewer may also perceive that the diffractive colour image dominates the appearance of the device, at least where it overlaps the one or more areas of diffractive whiteness, even where the diffractive whiteness is exhibited at this angle.

Each achromatic grating region comprises a plurality of grating sub-regions having different respective grating element pitches ranging from a coarse pitch to a fine pitch. In other words, the pitch of the grating elements within a sub-region is constant, and the pitch of one grating sub-region is different to the pitch of a different grating sub-region. The grating sub-regions are arranged such that, for each of a plurality of viewing angles within the respective viewing zone, the diffractive colours exhibited by the plurality of grating sub-regions cooperate such that the achromatic grating region is perceived to exhibit diffractive whiteness. In other words, at a particular viewing angle within the respective viewing zone, a plurality of grating sub-regions within an achromatic grating region replay a corresponding respective range of visible colours from the far red to the far blue within the visible spectrum. Upon viewing of the device, this range of colours exhibited by the plurality of grating sub-regions is perceived by the human eye to appear substantially white, whereby the achromatic grating region exhibits diffractive whiteness. Each individual grating sub-region will have its own diffractive spectrum (i.e. variance of diffracted wavelength (colour) with viewing angle) in accordance with Equation 1. Thus, due to the range of pitches from a coarse pitch to a fine pitch within an achromatic grating region, a plurality of grating sub-regions will replay a corresponding plurality of “rainbow” colours from the visible spectrum at substantially each angle of tilt within the respective viewing zone. In this way, the human eye perceives an achromatic grating region to exhibit diffractive whiteness across substantially all viewing angles within the respective viewing zone.

The optical device comprises achromatic grating regions that differ in their average orientation so that they have different first and second viewing zones, i.e. since their diffractive dispersion planes are not parallel. The term “average orientation” here reflects that the grating elements may be curved, or that the achromatic grating regions may comprise a spread of different orientations of grating elements about a central angle in order to widen the range of viewing angles at which the effect may be perceived. In this case, the diffraction dispersion plane is considered to be the plane orthogonal to the average orientation of the grating elements. This corresponds to the principal plane within which the effect is observed, but as noted above the effect may be visible in a wider viewing zone, and indeed this is often desirable. It should be noted that the first and second viewing zones could be spaced from one another, e.g. so that at some angles between the two diffractive whiteness effects, substantially no effect is seen from either set of grating regions, they could abut one another, e.g. so that the device transitions substantially instantaneously from one diffractive whiteness effect to the other upon rotation of the device, or the viewing zones could partially overlap one another, i.e. so that at some viewing angles both of the diffractive whiteness effects are visible. The relative position of the viewing zones may be controlled by the orientations of the grating elements within the first and second achromatic grating regions. For example, if the first achromatic grating regions comprise a first range of orientations, such as from −30° to −10° relative to a reference orientation that is horizontal when the device is arranged vertically, and the second achromatic grating regions comprise a second range of orientations that do not overlap the first range of orientations, such as from ±10° to ±30° relative to the same reference orientation, then the associated viewing zones may appear spaced from one another. On the other hand, if the first range of orientations is substantially adjacent to the second range of orientations, e.g. the first range is from −20° to 0° and the second range is from 0° to +20°, then the first and second viewing zones may substantially abut one another. Finally, if the first range of orientations overlaps the second range of orientations, e.g. if the first range is from −15° to +5° and the second range is from −5° to +15°, then the first and second viewing zones may partially overlap.

Because achromatic grating regions rely on overlapping colours from different diffraction gratings, these do not typically exhibit much progression upon rotation of the device about the axis orthogonal to the viewing plane. Therefore, instead, such a device may be intended to held by a viewer so that each diffraction dispersion plane is aligned between horizontal and vertical, and thus, under typical viewing conditions, i.e. the device being illuminated from above and held substantially orthogonal to the viewing direction, the different achromatic effects may be switched between by rotating the device about the vertical axis so that the viewer moves between the two viewing zones. This viewing mode would correspond to one set of achromatic grating regions being oriented so that the grating elements are displaced clockwise from a horizontal orientation, and the other set of achromatic grating regions displaced anticlockwise from a horizontal orientation. Because the achromatic grating regions will typically exhibit their effect over a wide range of viewing angles within the vertical plane, the achromatic effect will typically be visible once the viewer has rotated the device about the vertical axis so that they are located in that viewing plane, and with not usually require any rotation about a horizontal axis in order to find the effect.

Meanwhile, the device includes the set of second grating regions which exhibits a first order diffractive effect at least at a first viewing angle. This diffractive device will typically have its own plane of diffractive dispersion, which will be at an angle to the plane of diffractive dispersion of both the first and second achromatic grating regions, i.e. the average orientation of the grating elements of the set of second grating regions may differ from the average orientation of the grating elements in both sets of achromatic grating regions. In contrast with the achromatic grating regions, the diffractive colour image will typically require some degree of rotation about the direction perpendicular to its viewing plane in order to locate the first order effect. Therefore, if the device is held with this viewing plane vertical, rotation about the horizontal axis may progress the diffractive colour effect of the grating in the set of second grating regions, causing the diffractive colour effect to appear and disappear, while rotation of the device about the vertical axis may cause different ones of the achromatic effects to become visible. This combination gives the device different optical variability in two different tilt directions, providing a very secure effect. This effect is particularly advantageous where the average orientation of the grating elements of the set of second grating regions is at an oblique angle to the average orientation of the grating elements in both the first and second achromatic regions, or in other words the principal plane of diffractive dispersion of the set of second grating regions is not orthogonal to either of the principal planes of diffractive dispersion of the first and second grating regions.

As mentioned above, the set of first grating regions is interlaced with the set of second grating regions. It should be noted that, within this, the first achromatic grating regions may also be interlaced with the second achromatic grating regions. The interlacing may be regular or irregular, and the first grating regions and the second grating regions may be the same or different sizes. For example, in some cases, it may be preferred for the first grating regions to be larger than the second grating regions, so that the first achromatic grating regions, the second achromatic grating regions, and the second grating regions each have equal weighting within the device, in which case the first grating regions may be larger than the second grating regions.

Of course, it will be preferred for the diffractive whiteness effect to present to the viewer the appearance of an image. Therefore, preferably the first achromatic grating regions are arranged in accordance with a first image such that a viewer viewing the device perceives a first diffractive whiteness image for a plurality of viewing angles within the first viewing zone. Likewise, preferably the second achromatic grating regions are arranged in accordance with a second image such that a viewer viewing the device perceives a second diffractive whiteness image for a plurality of viewing angles within the second viewing zone. Preferably these images are different from one another and/or different from the colour image that is provided by the set of second grating regions. Particularly preferably the first image is the inverse of the second image. As with the previously described devices, each first or second achromatic grating region may be thought of as a small part of the corresponding image being presented. If the first image is, for example, a letter or number on a blank background, then the first achromatic regions should be provided in areas of the device corresponding to the body of the letter or number and omitted in areas of the device outside of the body of the letter or number so that when the device is viewed in the first viewing zone, the viewer sees the letter or number defined by areas of diffractive whiteness against a blank background in which there is no diffractive whiteness. Where the second image is the inverse of the first image, those areas outside of the body of the letter or number would instead be provided with second achromatic regions, so that when the device is viewed in the second viewing zone, the viewer sees the background to the letter or number defined by areas of diffractive whiteness with the body of the letter or number being areas in which there is no diffractive whiteness. As mentioned above, similarly the second grating regions are arranged in accordance with the colour image, i.e. a third image. The interlacing of the first and second grating regions, allows the colour image to appear to a user as overlapping the first and/or second images provided by the achromatic grating regions. Further interlacing of the first achromatic grating regions with the second achromatic grating regions, across the first grating regions, would also allow the first image to be perceived as overlapping the second image.

It will be preferred for the different achromatic grating regions to have viewing zones sufficiently separated from one another that the diffractive whiteness effects provided by the first and second achromatic grating regions can readily be viewed separately from one another. Therefore, preferably the average orientation of the grating elements of the first achromatic grating regions differ from the average orientations of the second achromatic grating regions by between 30° and 90°, preferably between 45° and 75°, more preferably between 50° and 70°, and further preferably all of the grating elements within the first achromatic grating regions differ from all of the grating elements within the second achromatic grating regions at least 10°, preferably by at least 20°, more preferably by at least 30°.

As alluded to above, preferably the average orientation of the second grating elements differs from the average orientation of the first grating elements in the first achromatic grating regions by between 10° and 60°, preferably between 20° and 50°, most preferably by approximately 30° and/or differs from the average orientation of the first grating elements in the second achromatic grating regions by between 10° and 60°, preferably between 20° and 50°, most preferably by approximately 30°. This allows the device to be arranged so that the plane of diffractive dispersion of the second grating elements is between the first and second viewing planes, e.g. substantially vertical, which would allow rotation about the horizontal axis to control the replay of the diffractive colour image and rotation about the vertical axis to switch to either the diffractive whiteness of the first achromatic grating regions or the diffractive whiteness of the second achromatic grating regions depending on the direction of rotation. This sort of variability on both vertical and horizontal tilting is particularly recognisable by a typical user.

Preferably, the first and second grating elements are arranged such that a user viewing the device at the first viewing angle perceives the diffractive colour image overlapping the one or more areas of diffractive whiteness exhibited by the achromatic grating regions by at least 50% at the first viewing angle, preferably by at least 75%, more preferably by at least 90%, wherein most preferably the diffractive colour image is perceived as substantially entirely encompassing the one or more areas of diffractive whiteness exhibited by the achromatic grating regions at the first viewing angle. As mentioned above, at the first viewing angle, the diffractive colour image will typically dominate the appearance of the device where the diffractive colour image overlaps the one or more areas of diffractive whiteness, i.e. provided in the first and second images define by the diffractive whiteness. By providing that at least 50% of the one or more areas of diffractive whiteness are overlapped by the diffractive colour image, a greater proportion of those areas of diffractive whiteness can be directly obscured by the diffractive colour image.

Another way in which the diffractive colour image can be caused to dominate the appearance of the device at the first viewing angle, even when the diffractive whiteness is visible due to illumination conditions or multiple achromatic grating angles, is by configuring the first order diffractive effect displaying the diffractive colour image to appear at angles at which any appearance of the diffractive whiteness is caused predominantly by second order effects, which are inherently less bright. As explained above, the diffractive whiteness is generated by the overlapping of multiple colours and sometimes multiple diffraction orders at any one viewing angle, and so as the device is viewed progressively further from the direction of specular reflection, the diffractive whiteness will be generated by an increasing proportion of second order effects. Preferably, the one or more second grating pitches are smaller than the pitches of the grating elements in at least 70%, of the first and/or second achromatic grating sub-regions, preferably in at least 80%, more preferably in at least 90% of the first and/or second achromatic grating sub-regions, wherein most preferably the one or more second grating pitches are each smaller than the fine pitch (i.e. the smallest pitch) of the first and/or second achromatic grating sub-regions. Since a smaller grating pitch will exhibit its first order effect further from the direction of specular reflection, by ensuring that the pitch of the set of second grating structures is smaller than most of the pitches in the achromatic grating regions, it can be ensured that, at the first viewing angle, any diffractive whiteness that the diffractive colour image may be competing against is predominantly caused by second order diffractive effects. Alternatively, or additionally, the average pitch of the second grating elements in the second grating regions is substantially equal to or less than half of the average pitch of the grating elements in the first and/or second achromatic grating sub-regions. Again, this may provide that any diffractive whiteness that the diffractive colour image may be competing against is predominantly caused by second order effects.

Suitable pitches for the grating elements in the set of second grating regions may be less than 700 nm, preferably less than 550 nm, and/or between 300 nm and 700 nm, preferably between 300 nm and 600 nm. Such gratings generally produce first order effects at relatively steep viewing angles, under typical illumination conditions. While these are generally not used because they lack any diffractive replay at more natural viewing angles, the achromatic gratings in the present arrangement may provide effects visible at these viewing angles closer to the normal, in which case the diffractive colour image may have the striking effect of being revealed upon tilting. Furthermore, these small pitches may allow the diffractive colour effect to appear at viewing angles at which the achromatic gratings have progressed to predominantly second order effects.

For the achromatic grating regions, on the other hand, the plurality of grating sub-regions within each achromatic grating region may comprise: a fine grating sub-region having a fine grating element pitch of less than 1000 nm, preferably between 500 nm and 1000 nm, more preferably between 700 nm and 1000 nm; a coarse grating sub-region having a coarse grating element pitch of greater than or equal to 1500 nm, preferably between 1500 nm and 3000 nm, more preferably between 1500 nm and 2000 nm; and one or more intermediate grating sub-regions each having a grating element pitch that is between the coarse grating element pitch and the fine grating element pitch, and wherein the grating element pitches of the one or more intermediate grating sub-regions are different. It will be appreciated that various combinations of fine and coarse grating are possible, depending on the requirements as to viewing angle ranges for the diffractive whiteness effects. For example, generally, it is preferred for the fine grating element pitch to be between 500 nm and 1000 nm, and the coarse grating element pitch to be greater than or equal to 1500 nm, or more preferably for the fine grating element pitch to be between 700 nm and 1000 nm, and the coarse grating element pitch to be greater than or equal to 1500 nm, even more preferably for the fine grating element pitch to be between 700 nm and 1000 nm, and the coarse grating element pitch to be between 1500 nm and 3000 nm. These grating sizes will allow the diffractive whiteness to be exhibited over a relatively wide range of viewing angles within the respective viewing plane. A greater number of sub-regions may also provide a better diffractive whiteness effect, and so preferably each achromatic grating region comprises at least four intermediate grating sub-regions.

The arrangement of grating sub-regions and their respective pitches within an achromatic grating region may be such that: a first group of grating sub-regions comprises grating sub-regions corresponding to a first set of colour channels when viewed at a first viewing angle within the respective viewing plane (which is different to the first viewing angle referred to above, which is not within one of these viewing planes of the achromatic grating structures and instead relates to the diffractive colour image) which cooperate such that the achromatic grating region exhibits diffractive whiteness at said first viewing angle; and a second group of grating sub-regions comprises grating sub-regions corresponding to a second set of colour channels when viewed at a second viewing angle within the respective viewing plane different to the first viewing angle which cooperate such that the achromatic grating region exhibits diffractive whiteness at said second viewing angle. Preferably, the number and pitches of the grating sub-regions within an achromatic grating region will be such that, at a particular viewing angle, four or more grating sub-regions replay respective four or more colour channels which together are perceived to exhibit diffractive whiteness. The first group and the second group of grating sub-regions may comprise one or more common grating sub regions. For example, at a first viewing angle within the respective viewing zone, one grating sub-region may exhibit a red colour (i.e. colour channel) which in combination with the diffracted light from other grating sub-regions at the first viewing angle results in the achromatic grating region exhibiting diffractive whiteness. At a second viewing angle the same grating sub-region may exhibit a blue colour which in which in combination with other grating sub-regions at the first viewing angle results in the achromatic grating region exhibiting diffractive whiteness. In some embodiments, the number of colour channels that are replayed, and the colour channels themselves, may be substantially the same at each viewing angle. However, more typically the sets of colour channels may vary at different viewing angles. For example, at a first viewing angle within the respective viewing zone, two grating sub regions may replay respective colour channels that cooperate such that diffractive whiteness is perceived, and at a second viewing angle in that respective viewing zone, three or more grating sub regions may replay respective colour channels that cooperate with each other such that the device exhibits diffractive whiteness. Thus, the number of colour channels, and the colours of the channels themselves, replayed by each group of grating sub-regions may vary with viewing angle. At each viewing angle, the combination of colour channels replayed by the respective group of grating sub-regions cooperates such that diffractive whiteness is perceived across the domain of the achromatic grating region.

Preferably, each of the first grating regions are achromatic grating regions; however, some may alternatively be non-diffractive regions, for example planar regions.

The grating regions of the present device will preferably be coated with a reflection enhancing layer, preferably one that follows the contours of the relief structure, to enhance the brightness of the effects.

The grating sub-regions within an achromatic grating region are preferably arranged in a substantially contiguous manner. In other words, the grating sub-regions within an achromatic grating region abut each other. However, alternatively there could be some spaces. Preferably, each grating sub-region within an achromatic grating sub-region has the same dimensions. In other embodiments, there could be different size sub-regions. For example, each grating may have the same number of grating element repeats.

As alluded to above, in order to provide that the diffractive whiteness effect is visible over a greater range of viewing angles orthogonal to the plane of diffractive dispersion, each achromatic grating region may be provided with sub-regions having different orientations. These are different sets of sub-regions to those described above having different pitches. Typically, each pitch will be provided with multiple different orientations to ensure that the diffractive whiteness effect is clear at all viewing angles. Preferably the grating elements of at least two grating sub-regions within an achromatic grating region have different orientations within the plane of the device, wherein preferably the different orientations differ by 30° or less, preferably by 20° or less. As mentioned above, where there are multiple orientations, the principal plane of diffractive dispersion is considered to be the plane orthogonal to the average orientation. This relatively tight distribution of orientations ensures that the diffractive whiteness still appears as one discrete effect, and just enhances the visibility of this effect, while also allowing strong discrimination between the diffractive whiteness and the diffractive colour image. Alternatively, or additionally, the grating elements within at least one achromatic grating region may be curved, which may achieve a similar effect.

Similarly, the visibility of the diffractive colour image may be improved by providing that one or more, preferably each, of the second grating regions comprises a plurality of second grating sub-regions, wherein the second grating elements of said second grating sub-regions have different orientations within the plane of the device. Again, the orientations of the grating elements in these sub-regions could differ by as much as 90° to provide the maximum visibility over rotationabout the vertical axis. However, preferably the different orientations differ by 60° or less, preferably by 40° or less, more preferably by 30° or less, most preferably by 20° or less. Again, alternatively or additionally, the grating elements within at least one second grating region may be curved.

Preferably, the second grating regions comprise a plurality of second grating regions and/or sub-regions having different second grating pitches, such that the second grating regions and/or sub-regions exhibit multiple diffractive colours at the first viewing angle. This increases the complexity and hence the security of the device, and furthermore the use of multiple colours can assist in allowing the diffractive image to dominate over the diffractive whiteness effects, as the higher complexity prevents the viewer from recognising any image displayed by the achromatic grating regions. To ensure that the different grating pitches replay at substantially the same angle, preferably the different second grating pitches differ by no more than 300 nm, preferably no more than 200 nm, most preferably no more than 150 nm. Typically, said regions and/or sub-regions having different grating pitches are arranged in accordance with the different colours of the colour image. It should be noted that the use of gratings having different pitches includes grating regions that are wholly one pitch or another, with the pitch differing from one grating region to the next, as well as individual grating regions that are composed of multiple sub-regions having gratings of different pitches.

While the possibility of curved grating elements was noted above, preferably, the first and/or second grating elements are linear grating elements, as these are easier to manufacture.

As with the device described above, preferably the dimensions of each grating region are such that they are not discernible to the naked human eye. Also, preferably, each grating region has a narrowest dimension in the plane of the device of not more than 70 microns, preferably not more than 50 microns, more preferably no more than 30 microns. Indeed, in some cases, each grating region may have these dimensions in at least two orthogonal directions in the plane of the device. Preferably, each grating sub-region has a narrowest dimension in the plane of the device of not more than 30 microns, preferably not more than 15 microns, more preferably no more than 10 microns. Again, each sub-region may have these dimensions in at least two orthogonal directions in the plane of the device.

The interlacing of the grating regions could be a one dimensional interlacing. That is, each grating region could be elongate along a first direction, and the grating regions could be interlaced along a second direction orthogonal to the first direction. However preferably, the set of first grating regions is interlaced with the set of second grating regions in a grid pattern, such that the first grating regions are interlaced with the second grating regions along two directions. The repeating dimension of the interlacing is preferably smaller than that resolvable by the naked human eye in order to avoid “macro” pattern artefacts being perceived when viewing the device. Thus typically, a repeat distance of the interlacing (e.g. the sum of the dimensions of adjacent first and second grating regions) is typically less than 100 microns, preferably less than 75 microns and more preferably 60 microns or less. Preferably, the first grating regions and the second grating regions are arranged in a substantially contiguous manner.

Particularly preferably, the optical device of the fifth aspect is a security device. In other words, the security device may be used to prevent copying or counterfeiting of an article or document to which it is applied.

In accordance with a sixth aspect of the invention there is provided a security article comprising a security device according to the fifth aspect of the invention, wherein the security article is preferably formed as a security thread, strip, foil, insert, patch, or substrate for a security document.

In accordance with a seventh aspect of the invention there is provided a security document comprising a security device or a security article according the sixth aspect of the invention, the security document preferably comprising a banknote, cheque, passport, identity card, certificate of authenticity, fiscal stamp or another document for securing value or personal identity.

In accordance with an eighth aspect of the invention, there is provided a method of manufacturing an optical device that exhibits a variable optical effect upon illumination, the method comprising: a set of first grating regions, wherein each first grating region comprises a plurality of first grating elements, wherein at least a subset of the first grating regions comprise first achromatic grating regions, wherein each first achromatic grating region comprises a plurality of first achromatic grating sub-regions having different respective grating element pitches ranging from a coarse pitch to a fine pitch and arranged such that, for a plurality of viewing angles within a first viewing zone, the diffractive colours exhibited by the plurality of first achromatic grating sub-regions upon illumination cooperate such that the first achromatic grating region is perceived to exhibit diffractive whiteness by a viewer viewing the device, and wherein at least a subset of the first grating regions comprise second achromatic grating regions, wherein each second achromatic grating region comprises a plurality of second achromatic grating sub-regions having different respective grating element pitches ranging from a coarse pitch to a fine pitch and arranged such that, for a plurality of viewing angles within a second viewing zone, the diffractive colours exhibited by the plurality of second achromatic grating sub-regions upon illumination cooperate such that the second achromatic grating region is perceived to exhibit diffractive whiteness by a viewer viewing the device, wherein the grating elements of the second achromatic grating regions have a different average orientation from the grating elements of the first achromatic grating regions, such that the first and second viewing zones are different; a set of second grating regions, wherein each second grating region comprises a plurality of second grating elements, the second grating elements having one or more second grating pitches, wherein the one or more second grating pitches are smaller than the pitches of the grating elements in at least 80% of the first and/or second achromatic grating sub-regions, such that upon illumination the second grating elements exhibit a first order diffractive effect at a first viewing angle, the second grating elements being arranged such that a user viewing the device at the first viewing angle perceives a diffractive colour image; and wherein the set of first grating regions is interlaced with the set of second grating regions such that a user viewing the device at the first viewing angle perceives the diffractive colour image as at least partially overlapping one or more regions of diffractive whiteness exhibited by the achromatic grating regions.

This method may be used to manufacture any device described above with respect to the fifth aspect of the invention. The resulting device provides all of the benefits already discussed above with respect to the fifth aspect of the invention.

In preferred embodiments the diffractive structure is formed by: providing a replication tool having a surface relief defining the diffractive structure; and using the replication tool to form the surface relief of the carrier layer according to the surface relief, and preferably applying a reflection enhancing layer onto the carrier layer so as to follow the contours of the surface relief. The replication tool may be manufactured by creating the surface relief in a recording medium and preferably transferring the surface relief to the surface of the replication tool.

The surface relief may be formed in the recording medium using maskless lithography such as electron beam lithography or direct laser writing. Electron beam lithography and direct laser writing can produce grating elements with pitches or spacings less than 500 nm.

### BRIEF DESCRIPTION OF DRAWINGS

Exemplary embodiments of the invention will now be described, by way of example only, with reference to the appended Figures, in which:

FIG. 1 is a schematic plan view of a security document comprising a security device;

FIG. 2 is an enlarged schematic view of a portion of a security device illustrating suitable grating regions;

FIGS. 3A and 3B illustrate, schematically, the appearance of a set of first grating regions of the security device at two different viewing angles;

FIGS. 4A and 4B illustrate, schematically, the appearance of a set second of grating regions of the security device at two different viewing angles;

FIGS. 5A and 5B illustrate, schematically, the combined appearance of the sets of first and second grating regions of the security device at two different viewing angles;

FIG. 6 is an alternative enlarged schematic view of a portion of a security device illustrating suitable grating regions;

FIGS. 7A and 7B illustrate, schematically, an alternative appearance of the security device at two different viewing angles;

FIG. 8 shows, schematically, another security device with a number of areas of the device enlarged to illustrating suitable grating regions; and

FIG. 9 illustrates schematically, the appearance of the security device at three different viewing angles;

FIGS. 10A and 10B illustrate, schematically, the appearance of the first set of grating regions and the second set of grating regions of the security device respectively; and

FIGS. 11A and 11B the combined appearance of the sets of first and second grating regions of the security device at two different viewing angles.

### DETAILED DESCRIPTION

Grating regions of the optical device according to the invention may have various different forms (e.g. amplitude-or phase-based). The following description will focus on diffractive structures formed as a surface relief (i.e. phase-difference devices rather than amplitude-different devices) since these lend themselves well to large volume replication. Throughout the figures, the lines used to illustrate individual grating elements are schematic and do not necessarily indicate the exact number of grating elements within a grating region or grating sub-region. The lines used to illustrate the individual grating elements represent the maximum heights, or “peaks”, of the surface relief.

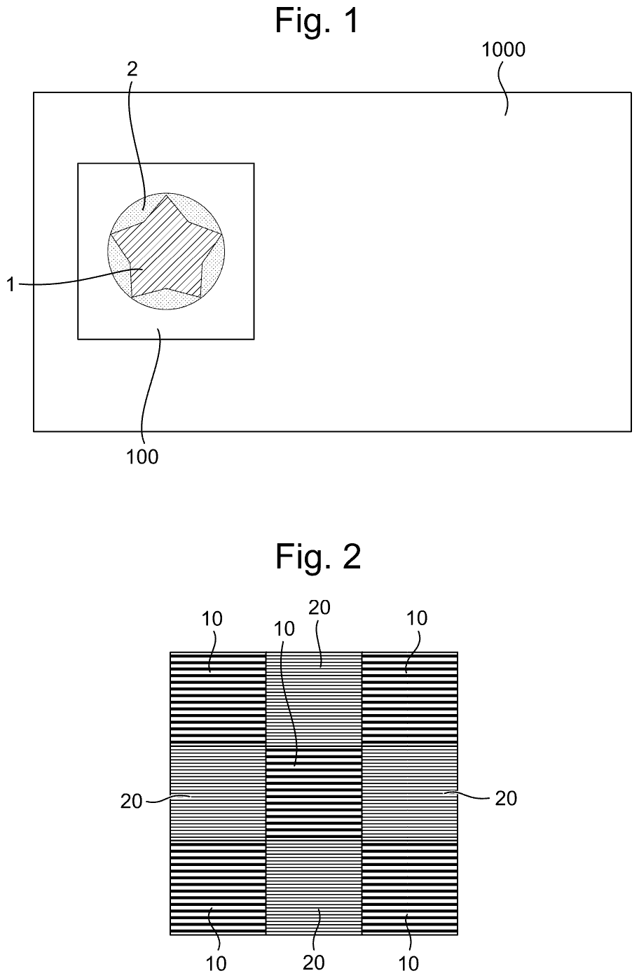

FIG. 1 is a plan view of a security document 1000 (here in the form of a banknote) comprising an optical device 100 according to the present invention.

Here, the optical device is used to help prevent forgery, copying or counterfeiting of the banknote, and is therefore a security device. FIG. 1 shows the security document carrying a security device according to the first aspect of the invention; however, this could equally carry a security device according to the fifth aspect of the invention. The security document shown in FIG. 1 carries a security device which exhibits a diffractive colour image that changes from a first appearance, in this case the image of a star 1, to a second appearance, in this case the image of a circle 2, upon rotation about the horizontal axis lying in the plane of the security device. The mechanism producing this effect will now be described in detail.

FIG. 2 shows a small portion of the security device 100, illustrating that this device is composed of an array interlaced grating regions 10, 20. In particular, this device comprises a set of first grating regions 10 and a set of second grating regions 20. Each grating region is a square portion of the security device having dimensions of approximately 30 microns and so the individual regions will not be discernible to the naked human eye. The sets of first and second grating regions are interlaced in a grid or checkerboard pattern, so that along two orthogonal directions there is an alternating between the first and second grating regions. Each first grating region 10 essentially acts as a pixel in the first image 1, while each second grating 20 acts as a pixel in the second image 2. FIG. 2 shows an area of the device corresponding to a central part of both the first and second images, and so the first and second grating regions 10, 20 are disposed in each available space in the interlacing pattern. However, it will be appreciated that in other parts of the device, one or more of these regions within the interlacing pattern may be devoid of any grating structure in order to provide, e.g. corresponding to background regions of the first or second images that are not intended to appear with any diffractive colour.

In this embodiment, both the first and second images 1, 2 are intended to appear in substantially a single colour at any one viewing angle. Therefore, each first grating region 10 is provided with grating elements having a pitch of, for example 1000 nm, although any pitch in the range 700 nm to 1400 nm would be suitable. Each second grating region 20, on the other hand, is provided with grating elements having a pitch of, for example 500 nm, although again any pitch in the range 350 nm to 700 nm would be suitable. In this embodiment, the first and second grating regions are each provided with linear grating elements having the same orientation. Namely, these grating elements extend along a horizontal direction when the plane of the security device is arranged vertically. These diffraction gratings will thus act to diffract incident light within their diffractive dispersion planes, which are the planes perpendicular to the direction along which the grating elements extend.

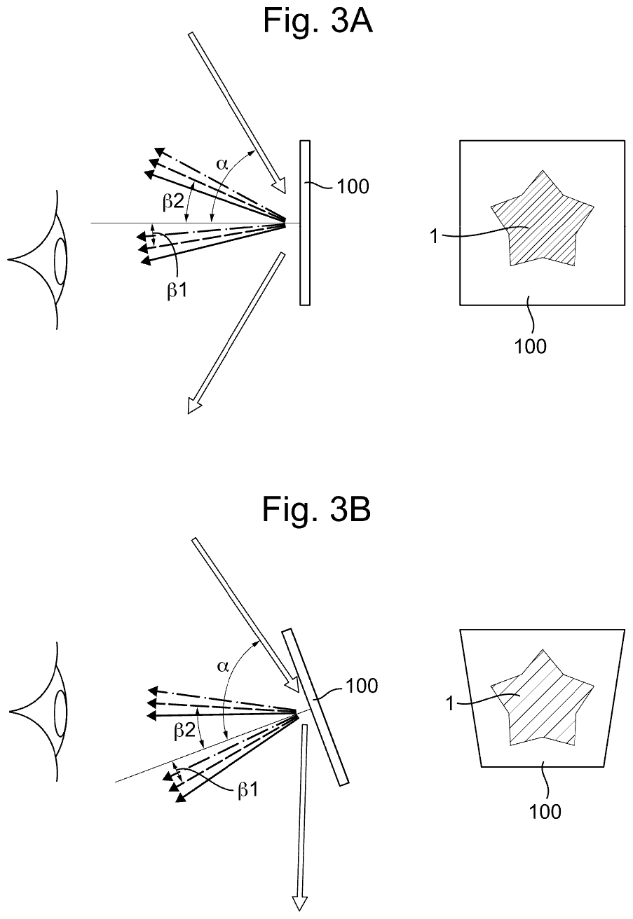

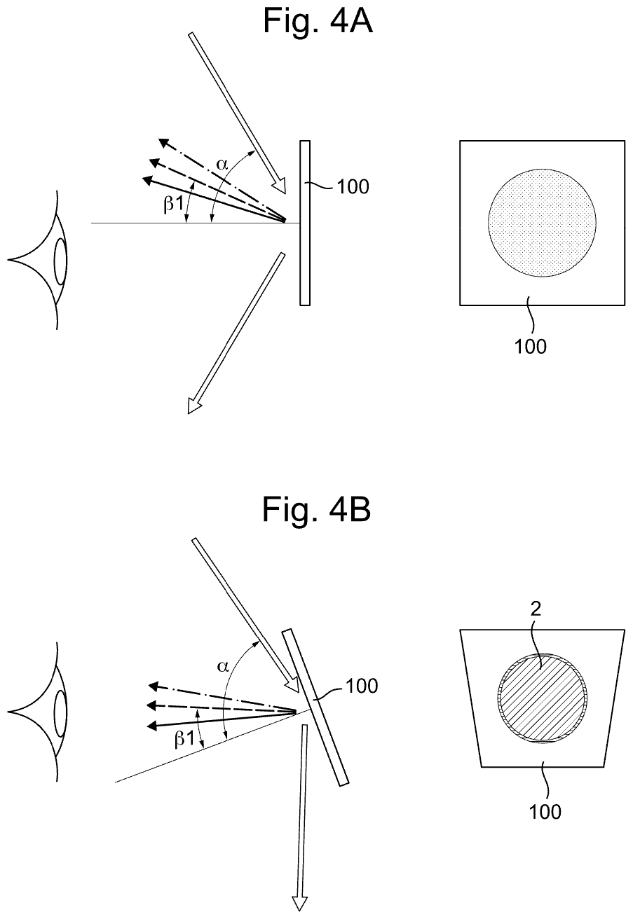

The pitches of these first and second grating regions have been selected so that these gratings exhibit diffractive effects as illustrated in FIGS. 3A to 4B.

FIGS. 3A and 3B illustrate the diffractive effects produced by the set of first grating regions having a pitch of 1000 nm. This illustrates that light is incident from overhead along an incidence angle α, which is close to 90° when the security device is held vertically as in FIG. 3A. The grating structure in the first grating regions 10 thus produces a first order diffractive effect along the direction β₁, as determined by Equation 1 above, β1 being close to normal to the security device and so may be perceived by a viewer. However, the grating structure in the first grating regions 10 also produces a second order diffractive effect along the direction B₂, again as determined by Equation 1 above, which is much steeper and closer to the original incidence angle.

In the viewing arrangement shown in FIG. 3A, i.e. where the viewer views the device close to normal to the plane of the security device, the viewer sees light diffracted into the first diffraction order from the first grating regions 10, and so sees a bright image 1 depicting a star. However, when the viewer rotates the device around its horizontal axis, the first order effect initially disappears, before the second diffraction order eventually becomes visible, as shown in FIG. 3B, and the viewer once again sees the image of the star. However, because the second diffraction order is much weaker than the first diffraction order, the image at this viewing angle is very dim.

FIGS. 4A and 4B illustrate the diffractive effects produced by the set of second grating regions having a pitch of 500 nm. When the security device is held vertically, i.e. as in FIG. 3A, the light is incident from overhead along an incidence angle α, which is close to 90°. The grating structure in the second grating regions 20 has half the pitch of the grating structure in the first regions. Therefore, the first order diffractive effect is exhibited along the direction β₁ in FIG. 4A, which as determined by Equation 1 above will be equal to the angle of the second diffraction order β₂ for the first grating regions 10 in FIG. 3A. Accordingly, the first diffraction order for the second grating regions 20 is not visible to the viewer viewing the security device along the direction of the first diffraction order for the first grating regions 10, and this is shown in FIG. 4A. When the viewer rotates the device around its horizontal axis, the first diffraction order eventually becomes visible, as shown in FIG. 4B, and the viewer sees the second image 2, in this case the image of a star.

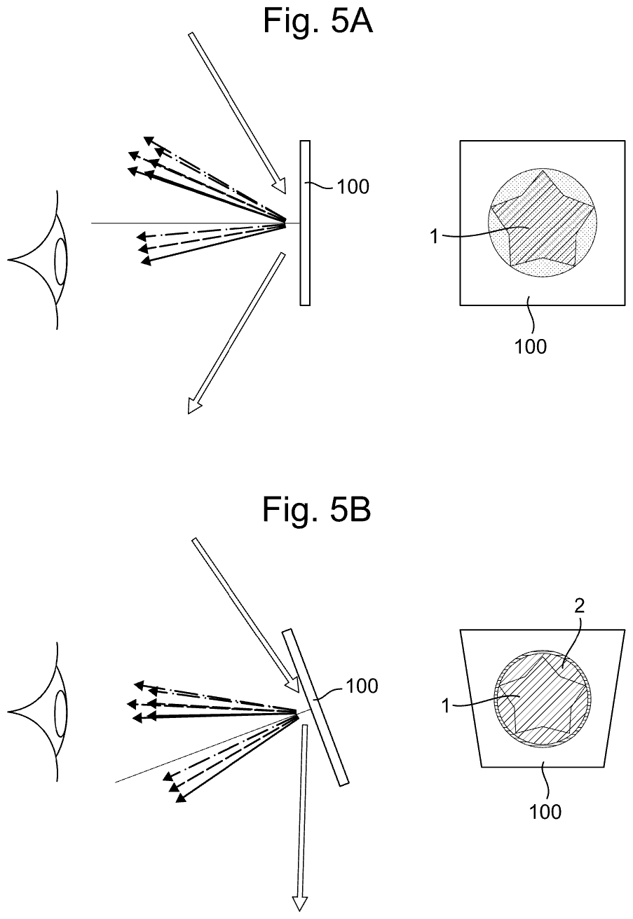

The description of FIGS. 3A to 4B look at only the contribution from the first grating regions or the second grating regions in order to demonstrate the principles underlying this device. The combined effect will now be described with reference to FIGS. 5A and 5B.

FIG. 5A illustrates the security device when viewed in the same position shown and described with reference to FIGS. 3A and 4A. In particular, the security device is held vertically, illuminated from above, and is viewed close to the normal to the plane of the device. Under these viewing conditions, for the reasons described above, the viewer will see the first image 1, displayed by the light in the first diffraction order from the set of first grating regions. The device will therefore have the appearance of a single coloured star at this viewing angle. Over small rotation angles, the colour of the star may appear to change as different colours are diffracted towards the viewer under the different viewing arrangements. The second image is not visible in any diffracted light, although the viewer may perceive the metallisation of those grating regions at this angle.

FIG. 5B illustrates the security device when viewed in the same position shown and described with reference to FIGS. 3B and 4B. In particular, the security device has been rotated about its horizontal axis so that the top of the device is closer to the viewer than the bottom. In this position, light from both the second diffraction order of the first grating regions and the first diffraction order of the second grating regions is directed towards the viewer. In this embodiment, the second image 2, i.e. the image of the circle has been selected so that it is perceived to completely overlap the first image 1, since the perimeter of the circle entirely surrounds the star. Because of the size and position of the second image 2, and because the first diffraction order of the second grating regions is significantly brighter than the second diffraction order of the first grating regions, at this viewing angle, the viewer sees only the second image 2. In FIG. 5B, the outline of the first image 1 is shown for illustrative purposes, but in practice no such outline will be visible to a viewer. Again, over small rotation angles, the second image 2 may appear to change as different colours are diffracted towards the viewer from both the first and second grating regions, but at all viewing angles at which these diffractive effects are exhibited, the second image 2 will dominate the appearance of the security device 100.

It will be noted that the gratings in the above embodiment are selected so that the second image 2 appears the same colour as the first image 1 where they would be exhibited together. This maximises the ability of the second image to conceal the appearance of the first image, but it is not essential. As mentioned above, because the first diffraction order of the second grating regions will be significantly brighter than the second order of the first grating regions, other grating pitches for the second regions, particularly those that differ from precisely half the pitch of the first grating regions, may be used and still achieve the apparent image switching effect described above.

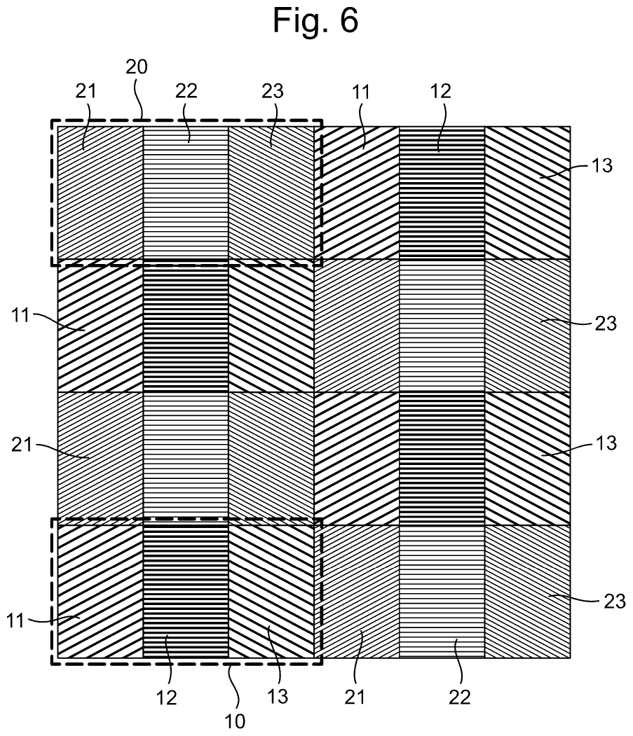

The above embodiment also utilises grating elements that all have the same orientation, namely horizontal when the plane of the security device is arranged vertically. However, such arrangements can be very sensitive to rotation around the vertical axis of the security device, meaning that the diffractive effects may very rapidly disappear if the viewer and light source are not properly aligned relative to this vertical axis. FIG. 6 illustrates a possible grating region arrangement that is more tolerant of small rotation angles around the vertical axis.

Like FIG. 2, FIG. 6 shows a small portion of the security device 100, again illustrating that this device is composed of an array interlaced grating regions 10, 20, which are again arranged in a grid or checkerboard arrangement, and act as pixels in generating an image to be displayed to a viewer. However, each first grating region 10 is composed of three equally sized sub-regions 11, 12, 13, and each second grating region 20 is similarly composed of three equally sized sub-regions 21, 22, 23.

Within each first grating region 10, the first sub-region 11 comprises grating elements having a pitch of 1000 nm, for example, and an orientation that is displaced relative to the horizontal orientation by 20° in the anticlockwise direction. The second sub-region 12 comprises grating elements having a pitch of 1000 nm, but with an orientation so that the grating elements extend along the horizontal direction. Finally, the third sub-region 13 comprises grating elements having a pitch of 1000 nm, but with an orientation that is displaced relative to the horizontal orientation by 20° in the clockwise direction. In other words, the grating elements in the third sub-region 13 are displaced by an angle of +20° relative to the grating elements in the second sub-region 12, and the grating elements in the first sub-region 11 are displaced by an angle of −20° relative to the grating elements in the second sub-region 12.

Within each second grating region 20, the first sub-region 21 comprises grating elements having a pitch of 500 nm, i.e. half of that in the first grating sub-regions 10, and an orientation that is displaced relative to the horizontal orientation by 20° in the anticlockwise direction. The second sub-region 22 comprises grating elements having a pitch of 500 nm, but with an orientation so that the grating elements extend along the horizontal direction. Finally, the third sub-region 23 comprises grating elements having a pitch of 500 nm, but with an orientation that is displaced relative to the horizontal orientation by 20° in the clockwise direction. That is, the second grating region 20 is composed of sub-regions having the same spread of orientations as in the first grating region, but the grating elements maintain the difference in pitch that has been described above.

By composing the security device 10 of grating regions so formed, the effect can be produced that was described above with respect to FIGS. 3A to 5B. However, now, this effect will be maintained over small rotation angles around the vertical direction. Assuming that initially the security device is held vertically and the viewer and the illuminating light source are both located in the plane of diffractive dispersion of the central sub-regions 12, 22, then the viewer will perceive the diffractive effect predominantly from the gratings in these sub-regions, although there may be some contribution from other sub-regions due to diffuse natural lighting. If the viewer were to then rotate the security device 10 about its vertical axis so that they move out of the diffractive dispersion plane of those central sub-regions, then they may instead perceive the effect being predominantly generated by one of the outer sub-regions 11, 13, 21, 23, since for these sub-regions the plane of diffractive dispersion is not oriented vertically due to the small azimuthal displacement of the grating elements in those sub-regions.

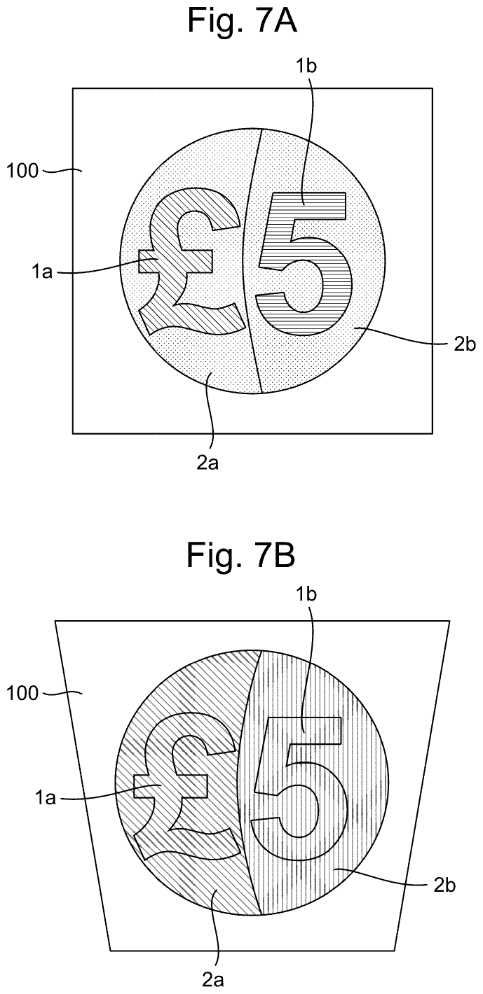

The effect described above with respect to FIGS. 1 to 5B was also described as a single colour effect; however, the present techniques can also be used to exhibit multi-colour effects, and such a security device will now be described with reference to FIGS. 7A and 7B.

In the security device according to this embodiment, the first image, which is defined by the set of first grating regions 10, is provided by the characters “£5”. This image is formed by two distinct areas: a first area 1a, which defines the character “£”, and a second area 1b, which defines character “5”. These first and second areas are intended to appear as different colours and so the first grating regions 10 located in the area 1a are provided with grating elements having one pitch, such as 1400 nm, and the first grating regions 10 located in the area 1b are provided with grating elements having a different pitch, such as 1200 nm.

Additionally, the second image, which is defined by the set of second grating regions 20, in this embodiment is provided by two parts 2a, 2b, of a circle in different colours, with a first area 2a being the left side of the circle and a second area 2b being the right side of the circle. In this case, the first area of the second image 2a is intended to be perceived as overlapping and entirely covering the character “£” defined by the first area 1a of the first image, while the second area of the second image 2b is intended to be perceived as overlapping and entirely covering the character “5” defined by the second area 1b of the first image. In order to maximise the ability of these first and second areas of the second image 2a, 2b to conceal the first and second areas of the first image 1a, 1b when the second order diffractive effect of those first grating regions is viewed, where the second grating regions 20 are located in the first area of the second image 2a, they are provided with a pitch of 700 nm, which is half of the pitch of the grating elements in the first area of the first image 1a. Likewise, where the second grating regions 20 are located in the second area of the second image 2b, they are provided with a pitch of 600 nm, which is half of the pitch of the grating elements in the second area of the first image 1b.

When this security device is held vertically with overhead lighting and viewed close to normal to the security device, as with the previous embodiment, the first image 1a, 1b will be perceived by the viewer as a result of the first order diffraction effect produced by the first grating regions 10. Because of the different grating pitches used in the first grating regions in the different areas 1a, 1b, these different parts of the first image will appear in different colours, as shown in FIG. 7A. In particular, the character “£” will appear in a first colour and the character “5” will appear in a second colour. These colours may both vary over small rotation angles about the horizontal axis of the security device, but will remain different, providing a multi-coloured image. Then, when the security device is rotated further about the horizontal axis of the security device, eventually these first order diffractive effects will disappear and, at some steeper viewing angle, the viewer will perceive the second image 2a, 2b, as shown in FIG. 7B, produced by the first order diffractive effect from the set of second grating regions 20. At this viewing angle shown in FIG. 7B, just as with the previous embodiment, the fist grating regions will be exhibiting their second order diffractive effect. However, because the first area of the first image 1a is completely overlapped by the first area of the second image 2a, and the second area of the first image 1b is completely overlapped by the second area of the second image 2b, the second image will conceal the first image due to the higher brightness of its first order diffractive effect. Furthermore, this concealing effect is enhanced since the second grating regions are provided with pitches such that the first area of the second image 2a has substantially the same colour as the first area of the first image 1a and the second are of the first image 2b has substantially the same colour as the second area of the first image 1b, where their respective first diffraction order and second diffraction order effects are visible simultaneously.

While the above embodiment is illustrated with only two differently coloured regions, it will be appreciated that more different colours may be used by providing different areas of the images with additional different pitches. Preferably, the pitches will be selected using Equation 1 so that these different colours are all exhibited together at least at one viewing angle for that image. To ensure that this is achieved for the first image, it may be preferred to ensure that the gratings within the first grating regions do not differ by more than 300 to 500 nm, and similarly it may be preferred to ensure that the gratings within the second grating regions do not differ by more than 150 to 250 nm. These multi-coloured images, whether using two different colours or more, can also of course be arranged in accordance with more complex imagery than that used here for illustrative purposes, and indeed increased complexity may further help the second image to conceal the first image.

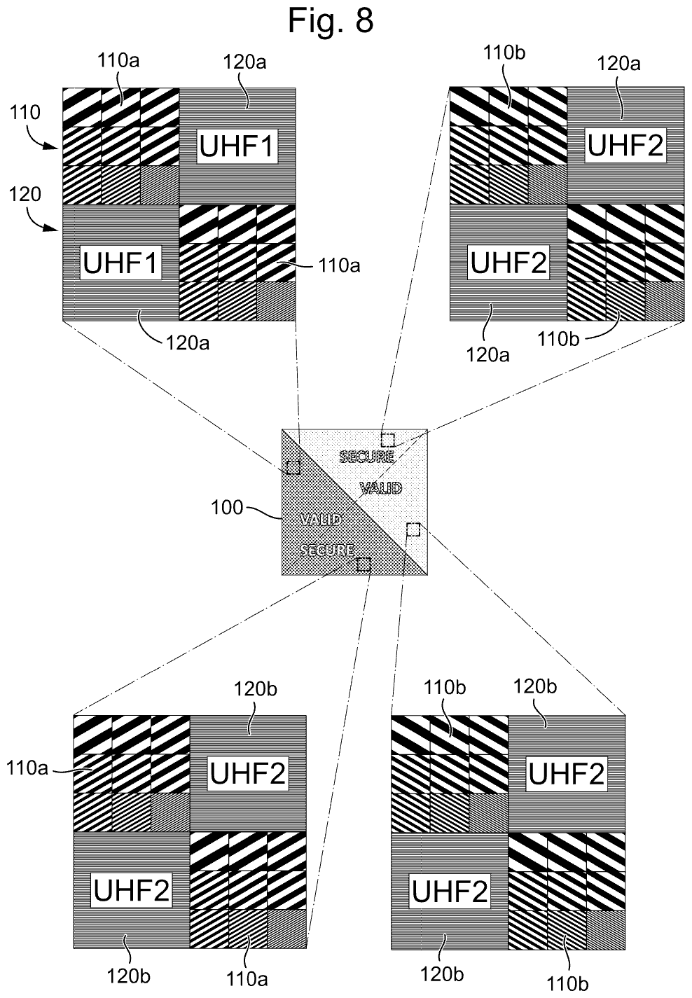

A security device according to another aspect of the invention will now be described with reference initially to FIG. 8.

FIG. 8 shows a security device 100, illustrating its appearance under a particular set of viewing conditions, the significance of which will be described further below. This security device is again composed of interlaced sets of first and second grating regions 110, 120, and the structure of these grating regions is different in different parts of the security device, as will be described. The security device has a square shape and is composed of four distinct main areas. A lower left half of the security element, delimited by the diagonal line running from the top left corner to the bottom right corner is an area associated primarily with a first achromatic diffractive effect, while an upper right half, delimited by that same diagonal line, is an area associated primarily with a second achromatic diffractive effect. Meanwhile, overlapping those areas just described, an upper left half of the device, delimited by the dashed diagonal line running from the top right corner to the bottom left corner, is an area associated primarily with a first colour of a diffractive colour effect, while a lower right half of the device, delimited by that same dashed diagonal line, is an area associated primarily with a second colour of a diffractive colour effect. FIG. 8 includes an enlarged portion of the grating regions in each of these areas. In this example, each grating region 110, 120 of the device has square geometry (such that its width is equal to its height), and has dimensions of 30 microns×30 microns, well below the resolution of the unaided human eye. The repeat distance R of the interlacing in both interlacing directions is 60 microns, which again is below the resolution of the naked human eye. This ensures that the observer does not perceive unintentional large-scale “macro” patterns within the device. The structure of the first and second grating regions in each of the areas identified above will now be described.

Firstly, illustrated in the upper left of FIG. 8, there is shown the structure of the first and second grating regions in a first part of the device. This corresponds to a part of the device that is in both the upper left and lower left halves of the security device and accordingly is associated with the first achromatic grating effect and with a first colour of the diffractive colour effect. In this area, the first grating regions 110 are first achromatic grating regions 110a, and the second grating regions 120 are a first subset of the second grating regions 120a.

Each first achromatic grating region 110a is itself composed of nine equally sized grating sub-regions arranged in a 3×3 grid within the first achromatic grating region 110a. In this example each grating sub-region has a square geometry (such that its width is equal to its height) and has dimensions of 10 microns×10 microns, well below the resolution of the unaided human eye such that the viewer will perceive the combined effect of the grating sub-regions across the domain of the achromatic grating region. Each one of these grating sub-regions has grating elements defining a grating with a different pitch. A coarsest of these grating sub-regions, positioned at the upper left position in the 3×3 grid, has a pitch of 2000 nm. A finest of these grating sub-regions, positioned at the bottom right position in the 3×3 grid, has a pitch of 700 nm. Those remaining sub-regions are intermediate grating sub-regions and these have respective grating element pitches that decrease one to the next between the coarse pitch to the fine. The grating frequency (=1/grating pitch) typically varies from one grating sub-region to the next in a linear fashion. The gratings in each of these first achromatic grating regions 110a is composed of linear grating elements and is provided with an orientation that is displaced 30° from the horizontal in an anticlockwise direction when the plane of the security device is arranged vertically. Each of these gratings will thus act to diffract light within their plane of diffractive dispersion, which is the plane perpendicular to the direction along which the grating elements extend.

Each one of the first subset of the second grating regions 120a, labelled UHF1 or ultra-high frequency grating 1, is provided with linear grating elements having a pitch of, for example, 500 nm. These grating elements extend along a horizontal direction when the plane of the security device is arranged vertically, and so differ from the grating elements in the first achromatic grating regions 110a by 30°.

Illustrated in the upper right corner of FIG. 8, there is shown the structure of the first and second grating regions in a second part of the device 100. This corresponds to a part of the device that is in both the upper left and lower right halves of the security device described earlier and accordingly is associated with the second achromatic grating effect and with the first colour of the diffractive colour effect. In this area, the first grating regions 110 are second achromatic grating regions 110b, and the second grating regions 120 are again part of the first subset of the second grating regions 120a.

Each second achromatic grating region 110a is again composed of nine equally sized grating sub-regions arranged in a 3×3 grid within the second achromatic grating region 110b, in much the same way described above for the first achromatic grating regions 110a. Again, each one of these grating sub-regions has grating elements defining a grating with a different pitch. A coarsest of these grating sub-regions, positioned at the upper left position in the 3×3 grid, has a pitch of 2000 nm. A finest of these grating sub-regions, positioned at the bottom right position in the 3×3 grid, has a pitch of 700 nm. Those remaining sub-regions are intermediate grating sub-regions and these have respective grating element pitches that decrease one to the next between the coarse pitch to the fine. The grating frequency (=1/grating pitch) typically varies from one grating sub-region to the next in a linear fashion. The gratings in each of these first achromatic grating regions 110b is composed of linear grating elements and is provided with an orientation that is displaced 30° from the horizontal in an clockwise direction when the plane of the security device is arranged vertically. This orientation therefore differs from the orientation of the grating elements in the first achromatic grating regions 110a, but the pitches are the same. Each of the gratings in the second achromatic grating region will again act to diffract light within their plane of diffractive dispersion, which is the plane perpendicular to the direction along which the grating elements extend.

The second grating regions 120a in this part of the security device are the same as those described above as UHF1. These grating elements lie along the horizontal direction and have a pitch of 500 nm.

In the lower left in FIG. 8, there is shown the structure of the first and second grating regions in a third part of the device 100. This corresponds to a part of the device that is in both the lower left and lower right halves of the security device described earlier and accordingly is associated with the first achromatic grating effect and with a second colour of the diffractive colour effect. In this area, the first grating regions 110 are first achromatic grating regions 110a, and the second grating regions 120 are part of a second subset of the second grating regions 120a.

In this part of the device, each first grating region is a first achromatic grating sub-region 110a and is as has been described above, composed of nine different grating pitches, oriented 30° anticlockwise from the horizontal orientation of the ultra-high frequency grating.

The second grating regions, on the other hand, in this part of the device are part of the second subset of the second grating regions 120b, which are labelled UHF2 or ultra-high frequency grating 2 in the Figure. Each of these grating regions is provided with linear grating elements having a pitch of, for example, 400 nm, i.e. less than the pitch of the grating elements in the first subset of the second grating regions 120a. These grating elements again extend along a horizontal direction when the plane of the security device is arranged vertically.

Finally, illustrated in the lower right of FIG. 8 there is shown the structure of the first and second grating regions in a fourth part of the device 100. This corresponds to a part of the device that is in both the upper right and lower right halves of the security device described earlier and accordingly is associated with the second achromatic grating effect and with the second colour of the diffractive colour effect. In this area, the first grating regions 110 are again second achromatic grating regions 110b, and the second grating regions 120 are again part of the second subset of the second grating regions 120b.

In this part of the device, each first grating region is a second achromatic grating sub-region 110b and is as has been described above, composed of nine different grating pitches, oriented 30° clockwise from the horizontal orientation of the ultra-high frequency gratings.

The second grating regions 120a in this part of the security device are the same as those described above as UHF2. These grating elements lie along the horizontal direction and have a pitch of 400 nm.

With the above structure, the first grating regions in the lower left half of the security device define an area that is predominantly a first achromatic diffractive effect and in the upper right half of the security device define an area that is predominantly a second achromatic diffractive effect. The exception to this is regions in the lower left half of the security device, which define the words “VALID” and “SECURE”, in which the first grating regions are second achromatic grating regions. Likewise in the upper right half of the device there are again the words “VALID” and “SECURE”, in which this time the first grating regions are first achromatic grating regions as described above. Similarly, the second grating regions in the upper left half of the security device define an area that is predominantly a first colour of the diffractive colour effect provided by the 500 nm grating and in the lower right half of the security device define an area that is predominantly a second colour of the diffractive colour effect provided by a 400 nm grating. Again, the exception in these areas is that the upper left half of the device includes an area defining a prohibition sign in which the grating instead has a pitch of 400 nm, and likewise in the lower right half of the device there is an area defining a prohibition sign in which the grating instead has a pitch of 500 nm.

It should be noted that the first achromatic grating regions, the second achromatic grating regions, and the second grating regions, are all described as having only one respective orientation. However, as described above with regard to FIG. 6, it may be preferred to break each grating region, or sub-region, down into further sub-regions with a plurality of different orientations for each pitch value. For example, for each first achromatic grating region 110a, each one of the nine different pitch sub-regions may be broken down into three sub-regions provided with three different orientations. This may be provided by a first orientation that is as described above for the first achromatic grating regions and then an orientation that differs by +10° and another that differs by −10°. In this case, the average orientation would remain the same, and so the principal plane of diffractive dispersion will remain the same as described above. Likewise, the second achromatic grating region may be provided with additional sub-regions for each pitch that differ by +10° and by −10° to produce the same effect. Finally, each second grating region may be split into three sub-regions, with again sub-regions that differ by +10° and by −10° from the centre orientation so that the diffractive colour image is more tolerant to viewing angle variations around the vertical axis. This arrangement will have the effect of making each of these diffractive effects more tolerant to rotation about the vertical axis of the security device. Furthermore, this range of orientations will also control the lateral size and position of the first and second viewing zones. For example, if the first achromatic grating regions comprise the orientations of −30°, −20° and −10° relative to the horizontal when the device is arranged vertically, and the second achromatic grating regions have orientations +10°, +20° and +30° relative to the same reference orientation, then the first and second viewing zones would be spaced from one another. In other embodiments, orientations in the first achromatic grating regions could be −20°, −10° and 0° and the orientations in the second achromatic grating regions could be 0°, +10° and +20°, and then the first and second viewing zones may substantially abut one another. Finally, in another embodiment, the orientations in the first grating regions could be −15°, −5° and +5° and the orientations in the second grating regions could be −5°, +5° and +15°, then the first and second viewing zones may partially overlap.

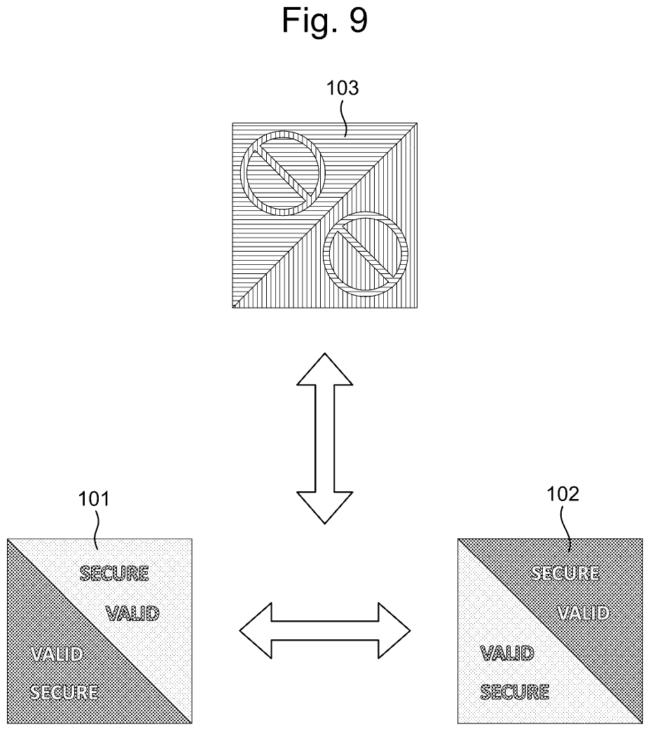

The effect produced by the structure described above with respect to FIG. 8 will now be described with reference to FIGS. 9 to 11B.

As has been described above, a security device such as this will typically be held by a viewer substantially vertically and illuminated from overhead. The present device is intended to be arranged so that the ultra-high frequency gratings in the second grating regions extend along the horizontal direction, with the elements in the first and second achromatic grating regions being displaced anticlockwise and clockwise respectively from this orientation. When the device is viewed close to normal to the device, only the diffractive effects from the first and second achromatic grating regions may be visible, since the ultra-high frequency grating in the second grating regions has a first diffraction order that is located at a relatively steep viewing angle. Thus, the differently angled principal planes of diffractive dispersion of the first and second achromatic grating regions, which lie either side of the vertical in this viewing arrangement, allow the viewer to switch between viewing a first image 101 defined by the first achromatic grating regions at viewing angles within a first viewing zone and viewing a second image 102 defined by the second achromatic grating regions at viewing angles within a second viewing zone by rotating the device about the vertical axis. The position and extent of these first and second viewing zones in the lateral direction of tilt are determined by the orientation(s) used for the gratings in the first and second achromatic grating regions respectively. The position and extent of the first and second viewing zone in vertical direction of tilt is determined by the pitch values used for the gratings in the first and second achromatic grating regions. However, when rotating the device from the viewing angle normal to the plane of the security device about its horizontal axis, the effect produced by the achromatic grating regions will diminish as second order effects start to become predominant and at a sufficiently steep viewing angle, the viewer will see the appearance of a third diffractive colour image 103 provided by the second grating regions.

Considering only the achromatic grating effects now, this effect has been described herein as diffractive whiteness. This effect is produced since, at any one viewing angle within the respective viewing zone, each of the different achromatic grating sub-regions will diffract towards the viewer light of a different colour. At one particular viewing angle, the finest grating sub-region may replay light towards the far blue of the visible spectrum. At this viewing angle, the nearest intermediate sub-regions may replay light shifting increasingly towards the red end of the visible spectrum as the sub-region pitch increases from sub-region to sub-region. The remaining sub-regions having a coarser pitch may typically not replay within the visible spectrum at this viewing angle. Nonetheless, the combination of the finest grating diffracting blue light towards the viewer and several of the next finest grating diffracting light progressing towards the red end of the visible spectrum may result in the perceived effect of a diffractive whiteness across the domain of the achromatic grating region. As the device is rotated from this viewing angle, the finest sub-region may now begin to replay outside of the visible spectrum, but each of the other gratings may shift to diffracting light closer to the blue end of the spectrum towards the viewer, with one or more of the coarser gratings now becoming active in the visible spectrum. This causes the diffractive whiteness effect to persist over a range of viewing angles with a component in the plane of diffractive dispersion defined by the orientation of the grating elements, contributing to the vertical extent of the viewing zones.

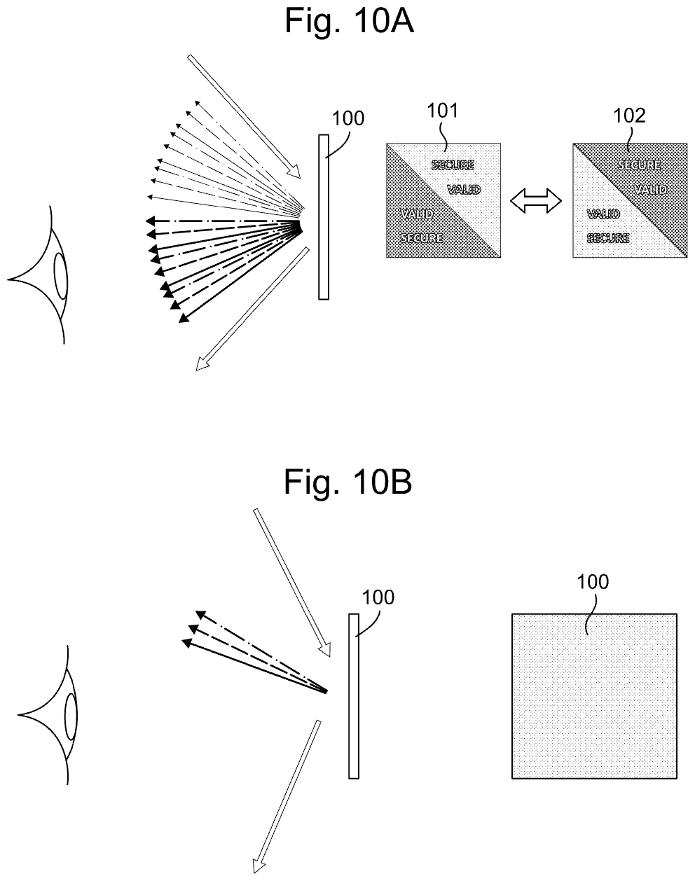

FIG. 10A shows only the diffractive replay of the achromatic grating regions 110a, 110b. As can be seen here, the pitches of the achromatic grating sub-regions are selected so that the diffractive whiteness effect is visible and particularly bright at viewing angles close to the normal, using Equation 1 given above. As can be seen in FIG. 10A, this diffractive whiteness effect will be strongest where the effect is generated by the first order effects of the gratings in the achromatic grating sub-regions, but may persist at steeper viewing angles, driven by second diffraction orders from the gratings. This is particularly true where the gratings have pitches in the range 700 nm to 3000 nm. As a result, these achromatic grating regions 110a, 110b, provided with different orientations defining two different viewing zones, provide a bright diffractive whiteness effect close to the normal viewing angle, and which exhibits a switch between the images defined by the first and second achromatic grating regions 110a, 110b respectively upon rotation about the vertical axis, but which diminish in brightness as the device is rotated about the horizontal axis.

FIG. 10B shows only the diffractive replay of the second grating regions 120a, 120b at a viewing angle close to the normal to the security device when illuminated from overhead. As can be seen here, because of the small pitch of gratings in these regions, substantially no diffractive effect will be exhibited to the viewer by these gratings at this viewing angle. Instead, the first order diffractive effect exists at steeper viewing angle, which must be accessed by rotating the security device about its horizontal axis.

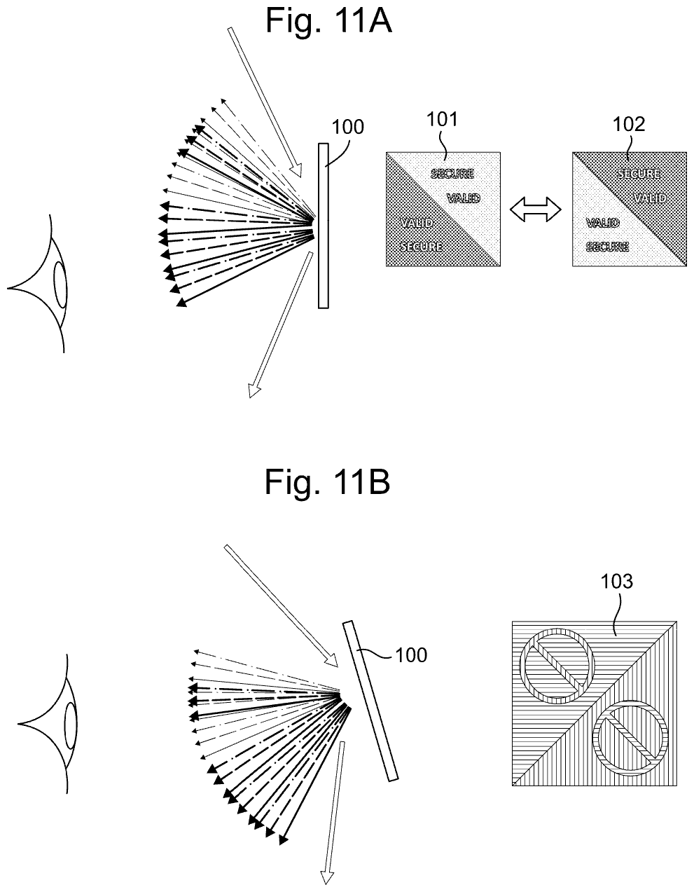

FIGS. 11A and 11B show the combination of the effects from the first and second grating regions. As shown in FIG. 11A, when the device is viewed close to the normal to the plane of the security device, the achromatic grating regions are perceived to display the first and second images 101, 102, which may be switched between by rotation about the vertical axis. These images are defined by the diffractive whiteness effect produced by the achromatic grating regions 110a, 110b by the mechanisms described above. It will be noted that the first and second images are the inverse of one another, which provides a particularly strong effect as the different areas of the device turn from bright to dark upon rotation about the vertical axis. As noted previously, and as shown in FIG. 11A, in this viewing arrangement and while switching between the first and second images defined by the achromatic grating regions 110a, 110b, the first diffraction order of the grating in the second grating regions 120a, 120b is outside of the line of site of the viewer, and so will not impact upon the perception of the first and second images.

However, when the device is rotated about the horizontal axis, as shown in FIG. 11B, now the third diffractive colour image appears, generated by the second grating regions 120a, 120b. This diffractive colour image 103 dominates the appearance of the security device and conceals any visibility of the first and second images 101, 102 from the achromatic grating regions. This is because the coarser pitches used for the achromatic grating regions means that any diffractive effect that would be visible from the achromatic grating regions at this angle will be predominantly caused by second or higher diffraction orders, which will be much less bright than the first diffraction order of the second grating regions 120a, 120b. As shown in the Figures here, the diffractive colour image completely overlaps both of the first and second images 101, 102 and conceals these at this viewing angle.

This diffractive colour image 103 that is visible at the viewing angle depicted in FIG. 11B is a multi-colour diffractive image, as a result of the different pitches used in the second grating regions in different areas of the device. In particular, the grating in the first subset of the second grating regions 120a having the pitch of 500 nm will exhibit a first colour at this viewing angle, while the grating in the second subset of the second grating regions 120b having the pitch of 400 nm will exhibit a second different colour at this viewing angle. These colours may vary together under small rotation angles about the horizontal axis of the security device.

The security devices described above may advantageously be manufactured by providing a replication tool having a surface relief defining the various diffractive structures that have been described above. This replication tool may be a casting cylinder for example. The replication tool may be used to form the surface relief of the carrier layer according to the desired surface relief. For example, the carrier layer may be a layer of curable material, as are well known in the art, and the process may involve forming the surface of the curable material and then curing the curable material by exposure to suitable radiation. The replication tool may be manufactured by creating the surface relief in a recording medium layer and transferring the surface relief to the surface of the replication tool. Maskless lithography such as electron beam lithography or direct laser writing, are particularly preferred techniques in this regard.
The following listing of claims will replace all prior versions, and listings, of claims in the application:

1. An optical device that exhibits a variable optical effect upon illumination, comprising:
a set of first grating regions, wherein each first grating region comprises a plurality of first grating elements, the first grating elements having one or more first grating pitches such that upon illumination the first grating elements exhibit at least a first order diffractive effect at a first viewing angle and a second order diffractive effect at a second viewing angle;
a set of second grating regions, wherein each second grating region comprises a plurality of second grating elements, the second grating elements having one or more second grating pitches smaller than the one or more first grating pitches such that upon illumination the second grating elements exhibit a first order diffractive effect substantially at the second viewing angle; and
wherein the set of first grating regions is interlaced with the set of second grating regions, and wherein the first grating elements are arranged in accordance with a first image and the second grating elements are arranged in accordance with a second image, such that a user viewing the device perceives the first image at the first viewing angle and perceives the second image at least partially overlapping the first image at the second viewing angle.

2. (canceled)

3. An optical device according to claim 1, wherein the second image is different from the first image, such that a user viewing the device perceives a switch from the first image to the second image upon moving from the first viewing angle to the second viewing angle.

4. An optical device according to claim 1, wherein the one or more first grating pitches are between 600 nm and 1500 nm, and/or wherein the one or more second grating pitches are less than 700 nm, and/or between 300 nm and 700 nm.

5. An optical device according to claim 1, wherein the one or more first and second grating pitches are selected such that the second image exhibited at the second viewing angles comprises substantially the same one or more diffractive colours as exhibited in the first image at the second viewing angle.

6. An optical device according to claim 1, wherein the first grating regions comprise a plurality of first grating regions and/or sub-regions having different first grating pitches, such that said first grating regions and/or sub-regions exhibit multiple diffractive colours at the first and second viewing angles.

7. (canceled)

8. An optical device according to claim 5, wherein the first grating regions are configured such that the first image exhibited at the second viewing angle comprises a plurality of areas of at least two distinct colours, and wherein the second grating regions are configured such that the second image exhibited at the second viewing angle comprises a plurality of areas of substantially the same two distinct colours, wherein the areas of those same colours are perceived to at least partially overlap at the second viewing angle.

9. (canceled)

10. An optical device according to claim 1, wherein the first grating elements and the second grating elements all have substantially the same orientation within the plane of the device.

11. An optical device according to claim 1, wherein more of the first grating regions comprises a plurality of first grating sub-regions, wherein the first grating elements of said first grating sub-regions have different orientations within the plane of the device, and/or more of the second grating regions comprises a plurality of second grating sub-regions, wherein the second grating elements of said second grating sub-regions have different orientations within the plane of the device.

12. (canceled)

13. An optical device according to claim 1, wherein the first and second grating regions are arranged such that the second image dominates the appearance of the device at the second viewing angle.

14. An optical device according to claim 1, wherein the first and second grating regions are arranged such that the second image is perceived as overlapping the first image by at least 50% at the second viewing angle.

15.-21. (canceled)

22. A method of manufacturing an optical device that exhibits a variable optical effect upon illumination, the method comprising:
forming a diffractive structure in a carrier layer, the diffractive structure comprising:
a set of first grating regions, wherein each first grating region comprises a plurality of first grating elements, the first grating elements having one or more first grating pitches such that upon illumination the first grating elements exhibit at least a first order diffractive effect at a first viewing angle and a second order diffractive effect at a second viewing angle;
a set of second grating regions, wherein each second grating region comprises a plurality of second grating elements, the second grating elements having one or more second grating pitches smaller than the one or more first grating pitches such that upon illumination the second grating elements exhibit a first order diffractive effect substantially at the second viewing angle; and
wherein the set of first grating regions is interlaced with the set of second grating regions, and wherein the first grating elements are arranged in accordance with a first image and the second grating elements are arranged in accordance with a second image, such that a user viewing the device perceives the first image at the first viewing angle and perceives the second image at least partially overlapping the first image at the second viewing angle.

23.-25. (canceled)

26. An optical device that exhibits a variable optical effect upon illumination, comprising:
a set of first grating regions, wherein each first grating region comprises a plurality of first grating elements, wherein at least a subset of the first grating regions comprise first achromatic grating regions, wherein each first achromatic grating region comprises a plurality of first achromatic grating sub-regions having different respective grating element pitches ranging from a coarse pitch to a fine pitch and arranged such that, for a plurality of viewing angles within a first viewing zone, the diffractive colours exhibited by the plurality of first achromatic grating sub-regions upon illumination cooperate such that the first achromatic grating region is perceived to exhibit diffractive whiteness by a viewer viewing the device, and wherein at least a subset of the first grating regions comprise second achromatic grating regions, wherein each second achromatic grating region comprises a plurality of second achromatic grating sub-regions having different respective grating element pitches ranging from a coarse pitch to a fine pitch and arranged such that, for a plurality of viewing angles within a second viewing zone, the diffractive colours exhibited by the plurality of second achromatic grating sub-regions upon illumination cooperate such that the second achromatic grating region is perceived to exhibit diffractive whiteness by a viewer viewing the device, wherein the grating elements of the second achromatic grating regions have a different average orientation from the grating elements of the first achromatic grating regions, such that the first and second viewing zones are different;
a set of second grating regions, wherein each second grating region comprises a plurality of second grating elements, the second grating elements having one or more second grating pitches, wherein the one or more second grating pitches are smaller than the pitches of the grating elements in at least 80% of the first and/or second achromatic grating sub-regions, such that upon illumination the second grating elements exhibit a first order diffractive effect at least at a first viewing angle, the second grating elements being arranged such that a user viewing the device at the first viewing angle perceives a diffractive colour image; and
wherein the set of first grating regions is interlaced with the set of second grating regions such that a user viewing the device at the first viewing angle perceives the diffractive colour image as at least partially overlapping one or more areas of diffractive whiteness exhibited by the achromatic grating regions.

27. An optical device that exhibits a variable optical effect upon illumination, comprising:
a set of first grating regions, wherein each first grating region comprises a plurality of first grating elements, wherein at least a subset of the first grating regions comprise first achromatic grating regions, wherein each first achromatic grating region comprises a plurality of first achromatic grating sub-regions having different respective grating element pitches ranging from a coarse pitch to a fine pitch and arranged such that, for a plurality of viewing angles within a first viewing zone, the diffractive colours exhibited by the plurality of first achromatic grating sub-regions upon illumination cooperate such that the first achromatic grating region is perceived to exhibit diffractive whiteness by a viewer viewing the device, and wherein at least a subset of the first grating regions comprise second achromatic grating regions, wherein each second achromatic grating region comprises a plurality of second achromatic grating sub-regions having different respective grating element pitches ranging from a coarse pitch to a fine pitch and arranged such that, for a plurality of viewing angles within a second viewing zone, the diffractive colours exhibited by the plurality of second achromatic grating sub-regions upon illumination cooperate such that the second achromatic grating region is perceived to exhibit diffractive whiteness by a viewer viewing the device, wherein the grating elements of the second achromatic grating regions have a different average orientation from the grating elements of the first achromatic grating regions, such that the first and second viewing zones are different;
a set of second grating regions, wherein each second grating region comprises a plurality of second grating elements, the second grating elements having one or more second grating pitches such that upon illumination the second grating elements exhibit a first order diffractive effect at least at a first viewing angle, the second grating elements being arranged such that a user viewing the device at the first viewing angle perceives a diffractive colour image; and
wherein the set of first grating regions is interlaced with the set of second grating regions such that a user viewing the device at the first viewing angle perceives the diffractive colour image as at least partially overlapping one or more areas of diffractive whiteness exhibited by the achromatic grating regions.

28.-29. (canceled)

30. An optical device according to claim 26, wherein the average orientation of the grating elements of the first achromatic grating regions differ from the average orientations of the second achromatic grating regions by between 30° and 90°.

31. An optical device according to claim 26, wherein the average orientation of the second grating elements differs from the average orientation of the first grating elements in the first achromatic grating regions by between 10° and 60°, and/or differs from the average orientation of the first grating elements in the second achromatic grating regions by between 10° and 60°.

32. An optical device according to claim 26, wherein the first and second grating elements are arranged such that a user viewing the device at the first viewing angle perceives the diffractive colour image overlapping the one or more areas of diffractive whiteness exhibited by the achromatic grating regions by at least 50% at the first viewing.

33. (canceled)

34. An optical device according to claim 26, wherein the average pitch of the second grating elements in the second grating regions is substantially equal to or less than half of the average pitch of the grating elements in the first and/or second achromatic grating sub-regions.

35. An optical device according to claim 26, wherein the one or more second grating pitches are less than 700 nm, preferably and/or between 300 nm and 700 nm.

36. An optical device according to claim 26, wherein the plurality of grating sub-regions within each achromatic grating region comprises: a fine grating sub-region having a fine grating element pitch of less than 1000 nm; a coarse grating sub-region having a coarse grating element pitch of greater than or equal to 1500 mm; and one or more intermediate grating sub-regions each having a grating element pitch that is between the coarse grating element pitch and the fine grating element pitch, and wherein the grating element pitches of the one or more intermediate grating sub-regions are different.

37.-52. (canceled)

53. A method of manufacturing an optical device that exhibits a variable optical effect upon illumination, the method comprising:
forming a diffractive structure in a carrier layer, the diffractive structure comprising:
a set of first grating regions, wherein each first grating region comprises a plurality of first grating elements, wherein at least a subset of the first grating regions comprise first achromatic grating regions, wherein each first achromatic grating region comprises a plurality of first achromatic grating sub-regions having different respective grating element pitches ranging from a coarse pitch to a fine pitch and arranged such that, for a plurality of viewing angles within a first viewing zone, the diffractive colours exhibited by the plurality of first achromatic grating sub-regions upon illumination cooperate such that the first achromatic grating region is perceived to exhibit diffractive whiteness by a viewer viewing the device, and wherein at least a subset of the first grating regions comprise second achromatic grating regions, wherein each second achromatic grating region comprises a plurality of second achromatic grating sub-regions having different respective grating element pitches ranging from a coarse pitch to a fine pitch and arranged such that, for a plurality of viewing angles within a second viewing zone, the diffractive colours exhibited by the plurality of second achromatic grating sub-regions upon illumination cooperate such that the second achromatic grating region is perceived to exhibit diffractive whiteness by a viewer viewing the device, wherein the grating elements of the second achromatic grating regions have a different average orientation from the grating elements of the first achromatic grating regions, such that the first and second viewing zones are different;
a set of second grating regions, wherein each second grating region comprises a plurality of second grating elements, the second grating elements having one or more second grating pitches, wherein the one or more second grating pitches are smaller than the pitches of the grating elements in at least 80% of the first and/or second achromatic grating sub-regions, such that upon illumination the second grating elements exhibit a first order diffractive effect at a first viewing angle, the second grating elements being arranged such that a user viewing the device at the first viewing angle perceives a diffractive colour image; and
wherein the set of first grating regions is interlaced with the set of second grating regions such that a user viewing the device at the first viewing angle perceives the diffractive colour image as at least partially overlapping one or more regions of diffractive whiteness exhibited by the achromatic grating regions.

54.-56. (canceled)
